(19) United States
(12) Patent Application Publication
(10) Pub. No.: US 2024/0116767 A1
(43) Pub. Date: Apr. 11, 2024

(54) Methods and Systems for Synthesizing Ammonia

(71) Applicant: Blue Planet Systems Corporation, Los Gatos, CA (US)

(72) Inventor: Kyle Self, San Jose, CA (US)

(21) Appl. No.: 18/201,532

(22) Filed: May 24, 2023

Related U.S. Application Data
(60) Provisional application No. 63/346,435, filed on May 27, 2022.

(51) Int. Cl. C01C 1/04; C01B 32/50; C25B 1/04

(52) U.S. Cl. CPC C01C 1/0405; C01B 32/50; C25B 1/04

(57) ABSTRACT

Methods and systems for synthesizing NH₃ with a very low CO₂ footprint are provided. A fuel is oxidized in a power generator to generate electrical energy and an exhaust comprising CO₂ and H₂O. CO₂ and H₂O in the exhaust are separated to produce a CO₂-depleted H₂O stream and a CO₂ stream. H₂O from the H₂O stream is electrolyzed using the generated electrical energy to synthesize gaseous O₂ and the H₂. The synthesized gaseous O₂ is used, at least in part, to oxidize the fuel in the power generator. The CO₂ in the CO₂ stream is sequestered. Ammonia (NH₃) with a very low CO₂ footprint is synthesized from the H₂ and gaseous N₂.

### CROSS-REFERENCE TO RELATED APPLICATIONS

Pursuant to 35 U.S.C. § 119(e), this application claims priority to the filing date of the U.S. Provisional Patent Application Ser. No. 63/346,435, filed May 27, 2022, the disclosure of which application is herein incorporated by reference.

### INTRODUCTION

Carbon dioxide (CO₂) is a naturally occurring chemical compound that is present in Earth's atmosphere as a gas. Sources of atmospheric CO₂ are varied, and include humans and other living organisms that produce CO₂ in the process of respiration, as well as other naturally occurring sources, such as volcanoes, hot springs, and geysers.

Additional major sources of atmospheric CO₂ include industrial plants. Many types of industrial plants (including cement plants, refineries, steel mills and power plants) combust various carbon-based fuels, such as fossil fuels and syngases. Fossil fuels that are employed include coal, natural gas, oil, petroleum coke and biofuels. Fuels are also derived from tar sands, oil shale, coal liquids, and coal gasification and biofuels that are made via syngas.

The environmental effects of CO₂ are of significant interest. CO₂ is commonly viewed as a greenhouse gas. The phrase “global warming” is used to refer to observed and continuing rise in the average temperature of Earth's atmosphere and oceans since the late 19th century. Because human activities since the industrial revolution have rapidly increased concentrations of atmospheric CO₂, anthropogenic CO₂ has been implicated in global warming and climate change, as well as increasing oceanic bicarbonate concentration. Ocean uptake of fossil fuel CO₂ is now proceeding at about 1 million metric tons of CO₂ per hour. Since the early 20th century, the Earth's mean surface temperature has increased by about 0.8° C. (1.4° F.), with about two-thirds of the increase occurring since 1980.

The effects of global warming on the environment and for human life are numerous and varied. Some effects of recent climate change may already be occurring. Rising sea levels, glacier retreat, Arctic shrinkage, and altered patterns of agriculture are cited as direct consequences, but predictions for secondary and regional effects include extreme weather events, an expansion of tropical diseases, changes in the timing of seasonal patterns in ecosystems, and drastic economic impact.

Projected climate changes due to global warming have the potential to lead to future large-scale and possibly irreversible effects at continental and global scales. The likelihood, magnitude, and timing is uncertain and controversial, but some examples of projected climate changes include significant slowing of the ocean circulation that transports warm water to the North Atlantic, large reductions in the Greenland and Western Antarctic Ice Sheets, accelerated global warming due to carbon cycle feedbacks in the terrestrial biosphere, and releases of terrestrial carbon from permafrost regions and methane from hydrates in coastal sediments.

While a matter of scientific debate, it is believed that excess atmospheric CO₂ is a significant contributing factor to global warming. Since the beginning of the Industrial Revolution, the concentration of CO₂ has increased by about 100 parts-per-million (ppm) (i.e., from 280 ppm to 380 ppm), and was recently observed to reach an average daily value of over 400 ppm. As such, there is great interest in the sequestration of CO₂, particularly in a manner sufficient to at least ameliorate the ever-increasing amounts of anthropogenic CO₂ that is present in the atmosphere. For example, the combustion of methane produces anthropogenic CO₂, as follows:

CH₄+2O₂→CO₂+2H₂O (I)

As illustrated in reaction (I), every mole of methane consumed produces one mole of CO₂ upon combustion.

Concerns regarding the effects of increased levels of atmospheric CO₂ on climate change have focused significant attention on the use of hydrogen as a transportation fuel, a source of power, and a means to reduce greenhouse gas emissions associated with difficult-to-decarbonize industries such as cement and steel. Hydrogen is attractive as a fuel source and reductant because, unlike hydrocarbons and other carbon-containing fossil fuel derivatives, it does not co produce carbon dioxide when combusted or oxidized. Hydrogen combustion proceeds as follows:

H₂+½O₂→H₂O (II)

As shown above in reaction (II), the only product of hydrogen combustion is water.

Despite the promise of hydrogen as zero-carbon energy source, the widespread deployment of hydrogen into energy and decarbonization markets faces a number of obstacles, a primary challenge being the production of hydrogen itself. Molecular hydrogen (H₂) is not naturally abundant. To meet future demand levels, molecular hydrogen must be produced from other hydrogen-containing molecules via a chemical reaction. Commercially, hydrogen is supplied as the result of various chemical processes. Some of these, such as the chlor-alkali process (for production of chlorine and caustic) and steam cracking (for olefin production), produce hydrogen as a by-product of the overall reaction chemistry. However, these processes are insufficient to meet the needs of the world's hydrogen demand.

To meet the overall demand, on-purpose hydrogen is generated primarily via a process known as steam-methane reforming (SMR). The SMR process, which dates to the early part of the 20th century, involves two chemical steps. In the first step, methane (CH₄) is reacted with water to produce hydrogen and carbon monoxide (CO):

CH₄+H₂O→3H₂+CO (III)

In the second step, additional hydrogen is produced via the water-gas shift (WGS) reaction:

CO+H₂O→H₂+CO₂ (IV)

Combining the two reactions above, we get an overall stoichiometry given by:

CH₄+2H₂O→4H₂+CO₂ (V)

Thus, for every molecule of methane consumed, the SMR/WGS system produces 4 molecules of hydrogen and one molecule of CO₂. When the produced CO₂ is vented to the atmosphere, the process has recently become known as “Gray Hydrogen” because of these associated CO₂ emissions. If the produced CO₂ is captured and processed so as to avoid release to the atmosphere, the process has become known as “Blue Hydrogen”. Although the process is referred to as steam-methane reforming, the reaction is not strictly limited to methane. Other hydrocarbon components of natural gas such as ethane, propane, and butane can also be reformed to hydrogen. In addition to steam methane reforming, there are other hydrocarbon reforming processes, such as autothermal reforming and partial oxidation, that can be used to generate hydrogen from hydrocarbons. The use of the term steam methane reforming (SMR) below is intended to be inclusive of other hydrocarbons and other processes which generate molecular hydrogen from those hydrocarbons.

There are a number of other molecules which can serve as the source of hydrogen, including water. The dominant process of generating hydrogen from water is known as water electrolysis as it involves the use of an electrochemical cell to separate hydrogen and oxygen from a water molecule, as follows:

H₂O→H₂+½O₂ (VI)

In reaction VI, energy, typically in the form of electrical energy, must be supplied to the system if the reaction is to proceed. If the electricity supplying the cell is 100% renewable, the hydrogen generated is known as “Green Hydrogen”.

### SUMMARY

The present inventors have realized that a fundamental challenge with conventional Green Hydrogen technologies is that there is no net production of usable energy. In particular, reaction (VI) provided in the Introduction section is the reverse of reaction (II). The second law of thermodynamics requires that the work produced in reaction (II) will never exceed the amount required for (VI)—some of that work will always be dissipated as heat. As a result, Green Hydrogen does not actually produce any net power, it merely provides additional portability (as in the case of transportation fuels) or storage for any low-carbon energy generated elsewhere. Moreover, if the energy supplied to the electrolysis process has an associated carbon footprint (as would normally be the case when the electric power is the result of fossil fuel consumption), the associated hydrogen carries the same carbon footprint and could not be classified as Green Hydrogen. Because the supply of low-carbon electricity is intermittent, the process economics of Green Hydrogen suffer intrinsically from issues such as high capital cost and low service factor. There is consequently a desire for a process which addresses the intermittency and cost of low-carbon power and produces net energy in the form of hydrogen without emitting significant levels of CO₂. Embodiments of the present invention satisfy this desire.

Aspects of the invention include methods of synthesizing NH₃. Methods of interest include oxidizing a fuel in a power generator to generate electrical energy and an exhaust comprising CO₂ and H₂O, separating most of the CO₂ from the exhaust to produce a CO₂-depleted H₂O stream, and electrolyzing H₂O from the CO₂-depleted H₂O stream using the generated electrical energy to synthesize gaseous O₂ and H₂. The synthesized gaseous O₂ subsequently oxidizes at least a portion of the fuel. Methods also include synthesizing ammonia (NH₃) from the H₂ and gaseous N₂. Power generators for use in the subject methods include, for example, gas turbines, gas boilers and heat recovery steam generators (HRSGs). In certain cases, fuels that may be oxidized include natural gas. In embodiments, separating most of the CO₂ from the exhaust includes sequestering the CO₂ from the exhaust, which further comprises contacting an aqueous capture liquid with the exhaust under conditions sufficient to produce an aqueous carbonate. Methods according to certain embodiments may also involve employing additional electrical energy, such as additional electrical energy obtained from a green power source (e.g., wind power source, hydroelectric power source, solar power source, hydrogen power source).

In some instances, methods include combining cations from a cation source and the aqueous carbonate under conditions sufficient to produce a CO₂ sequestering carbonate. In some embodiments, the cation source is a source of divalent cations, e.g., alkaline earth metal cations such as Ca²⁺ and Mg²⁺, and combinations thereof. The aqueous capture liquid may, in some cases, include an aqueous capture ammonia. In such cases, combining the cation source and the aqueous ammonium carbonate produces a CO₂ sequestering carbonate and an aqueous ammonium salt. Methods may additionally include regenerating aqueous capture ammonia from the aqueous ammonium salt. In some instances, the aqueous capture liquid comprises a proton-removing agent, such as where the aqueous capture liquid has a pH of 10 or more. Electrolysis protocols of interest for the subject methods include, for example, alkaline water electrolysis (AWE), proton exchange membrane (PEM) electrolysis, and solid oxide electrolysis (SOE).

Embodiments of the method include obtaining an O₂-containing gas (e.g., gas 209 in FIGS. 2A and 2B) from the surrounding atmosphere for oxidizing the fuel. In certain cases, the method comprises obtaining the O₂-containing gas via an air separation unit (ASU). In some versions, the ratio of synthesized gaseous O₂ to the obtained O₂-containing gas oxidizing the fuel ranges from 90:10 to 40:60. In certain instances, the O₂-containing gas further comprises CO₂ and obtaining the CO₂ in the O₂-containing gas comprises direct air capture (DAC). The CO₂ in the O₂-containing gas may additionally be sequestered, e.g., by one or more of the processes described above. For example, methods may include combining the CO₂ in the O₂-containing gas with the fuel. In embodiments, methods include obtaining gaseous N₂. In such embodiments, methods include synthesizing ammonia (NH₃) from the H₂ using the N₂. In some cases, methods include supplying the power generator with a CO₂ diluent from the exhaust to control the rate of oxidization. In some embodiments, methods involve limiting the amount of an oxidization component supplied to the power generator to control the rate of oxidization, and recycling the non-limited oxidization component to the power generator following oxidization. The oxidation components that may be limited include, for example, the synthesized gaseous O₂ and/or the fuel. Methods of interest may additionally include cooling the exhaust.

Aspects of the invention also include systems. Systems of interest include a power generator configured to oxidize a fuel to generate electrical energy and an exhaust comprising CO₂ and H₂O, a CO₂ sequestration unit gaseously connected to the power generator and configured to produce a CO₂-depleted H₂O stream, and an electrolyzer configured to electrolyze H₂O from the CO₂ depleted H₂O stream using the electrical energy from the power generator and synthesize gaseous O₂ and H₂. The electrolyzer described herein is gaseously connected to the power generator such that the synthesized gaseous O₂ oxidizes at least a portion of the fuel. Systems also include a reactor for synthesizing ammonia (NH₃) from the H₂ and gaseous N₂. The subject electrolyzer may be any convenient electrolyzer including, but not limited to, a solid oxide electrolysis (SOE) electrolyzer, an alkaline water electrolysis (AWE) electrolyzer, and a solid oxide electrolysis (SOE) electrolyzer.

Power generators may include, for example, gas turbines, gas boilers and heat recovery steam generators (HRSGs). In certain cases, the system is operably connected to an additional power source. The additional power source may, in some cases, be a green power source (e.g., wind power source, hydroelectric power source, solar power source, hydrogen power source).

In addition, the CO₂ sequestration units of interest may be configured to contact an aqueous capture liquid with the exhaust under conditions sufficient to produce an aqueous carbonate. In embodiments, the sequestration unit is configured to combine cations from a cation source and the aqueous carbonate under conditions sufficient to produce a CO₂ sequestering carbonate. In some embodiments, the cation source is a source of divalent cations, e.g., alkaline earth metal cations such as Ca²⁺ and Mg²⁺, and combinations thereof. The aqueous capture liquid may, in some cases, include an aqueous capture ammonia. In such cases, combining the cation source and the aqueous ammonium carbonate produces a CO₂ sequestering carbonate and an aqueous ammonium salt. Embodiments of the systems additionally include a reformer configured to regenerate aqueous capture ammonia from the aqueous ammonium salt. In some cases, the aqueous capture liquid comprises a proton-removing agent, such as where the aqueous capture liquid has a pH of 10 or more.

In some embodiments, the system is configured to obtain an O₂-containing gas from the surrounding atmosphere for oxidizing the fuel. In some such embodiments, the system further comprises an air separation unit (ASU) (e.g., ASU 208 as discussed with reference to FIGS. 2A and 2B) configured to obtain the O₂-containing gas. In certain cases, the ratio of synthesized gaseous O₂ to the obtained O₂-containing gas oxidizing the fuel ranges from 90:10 to 40:60. The system may additionally be configured to obtain an O₂-containing gas comprising CO₂, e.g., via a direct air capture (DAC) device configured to obtain gaseous CO₂ from the surrounding atmosphere. Embodiments of the system additionally include a gaseous connection for supplying the obtained gaseous CO₂ to the power generator and/or a gaseous connection for supplying the obtained gaseous CO₂ to the CO₂ sequestration unit. In certain versions, systems are configured obtain an O₂-containing gas comprising N₂. In some such versions, the system comprises a reactor configured to synthesize ammonia (NH₃) from the H₂ using the N₂.

Some embodiments of the subject systems include a diluent recirculation line connecting the CO₂ sequestration unit to the power generator. Diluent recirculation lines of interest may be configured to transport a CO₂ diluent to the power generator to control the rate of oxidization. In certain instances, the power generator is configured to limit the amount of an oxidization component supplied thereto to control the rate of oxidization, wherein the oxidization component is the gaseous O₂ or the fuel. In some cases, the power generator is configured to recycle the non-limited oxidization component following oxidization. Systems may additionally include a condenser configured to cool exhaust.

### BRIEF DESCRIPTION OF THE FIGURES

The invention may be best understood from the following detailed description when read in conjunction with the accompanying drawings. Included in the drawings are the following figures:

FIG. 1A provides a flowchart for synthesizing H₂ with a very low CO₂ footprint according to certain embodiments of the subject methods.

FIG. 1B provides a flowchart for synthesizing NH₃ with a very low CO₂ footprint according to certain embodiments of the subject methods.

FIGS. 2A-2B depict flow diagram for synthesizing H₂ according to certain embodiments of the subject methods.

FIGS. 3A-3E depict schematic block diagrams of systems for synthesizing H₂ according to certain embodiments.

### DETAILED DESCRIPTION

Methods and systems for synthesizing NH₃ with a very low CO₂ footprint are provided. A fuel is oxidized in a power generator to generate electrical energy and an exhaust comprising CO₂ and H₂O. CO₂ and H₂O in the exhaust are separated to produce a CO₂-depleted H₂O stream and a CO₂ stream. H₂O from the H₂O stream is electrolyzed using the generated electrical energy to synthesize gaseous O₂ and the H₂. The synthesized gaseous O₂ is used, at least in part, to oxidize the fuel in the power generator. The CO₂ in the CO₂ stream is sequestered. Ammonia (NH₃) with a very low CO₂ footprint is synthesized from the H₂ and gaseous N₂.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention.

The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### Methods of Synthesizing NH₃

As discussed above, methods of the invention include oxidizing a fuel in a power generator to generate electrical energy and an exhaust comprising CO₂ and H₂O, separating most of CO₂ from the exhaust to produce a CO₂-depleted H₂O stream, and electrolyzing H₂O from the CO₂-depleted H₂O stream using the generated electrical energy to synthesize gaseous O₂ and H₂. The gaseous O₂ synthesized via the subject methods oxidizes at least a portion of the fuel. The methods described herein may increase the net production of usable energy, such as where the net production of usable energy is increased by 5% or more, such as by 10% or more, such as by 25% or more, such as by 50% or more, such as by 75% or more, such as by 90% or more and including by 99% or more, e.g., as compared to a suitable control such as the SMR or Green Hydrogen protocols described in the Introduction section. In certain instances, the subject methods increase the net production of usable energy by 2-fold or more, such as by 3-fold or more, such as by 4-fold or more, such as by 5-fold or more and including by 10-fold or more, e.g., as compared to a suitable control such as the SMR or Green Hydrogen protocols described in the Introduction section. In some cases, the subject methods may additionally be sufficient to decrease the amount of gaseous CO₂ released into the atmosphere, such as where the amount of gaseous CO₂ released into the atmosphere is decreased by 5% or more, such as by 10% or more, such as by 25% or more, such as by 50% or more, such as by 75% or more, such as by 90% or more and including by 99% or more, e.g., as compared to a suitable control such as the SMR or Green Hydrogen protocols described in the Introduction section.

### Power Generation

As discussed herein, “oxidizing” is referred to in its conventional sense to refer to a process by which a certain element or compound is combined with oxygen, e.g., in a combustion reaction. The fuel oxidized in the subject methods may be any convenient hydrocarbon-containing fuel that is suitable for reacting with oxygen in a combustion reaction. In certain cases, the subject fuel is any fuel that produces both CO₂ and water when combusted. Fuels of interest may include, for example, one or more alkanes, alkenes, alkynes and aromatic compounds. In certain cases, fuels include methane (CH₄), ethane (C₂H₆), propane (C₃H₈), butane (C₄H₁₀), pentane (C₅H₁₂), hexane (C₆H₁₄), heptane (C₇H₁₆) or octane (C₈H₁₈), higher molecular weight compounds, and combinations thereof. In certain cases, the fuel oxidized in the present disclosure is a natural gas. The “natural gasses” discussed herein are referred to in their conventional sense to describe naturally occurring hydrocarbon gas mixtures. In certain cases, the fuel is a methane (CH₄)-containing natural gas. In such embodiments, the oxidization reaction may proceed according to reaction (I), discussed in the Introduction section:

CH₄+2O₂→CO₂+2H₂O (I)

In some embodiments, the subject natural gasses may additionally include one or more of the following: alkanes, CO₂, N₂, H₂S, and Hg. In some cases, the natural gasses employed herein have been subjected to natural-gas processing (i.e., the removal of impurities). In such cases, the natural gasses oxidized in the subject methods may have been processed such that one or more of the following have been removed: H₂S, Hg, H₂O, CO₂, high molecular weight compounds, and solids. Any suitable natural gas processing protocol may be employed. Natural gas processing is described in, e.g., U.S. Pat. No. 10,753,678; the disclosure of which is incorporated by reference herein in its entirety.

The above-described fuel may be oxidized in any suitable power generator. The “power generator” discussed herein may be any convenient device for generating electricity via the combustion of a fuel. The power generator may be configured to produce any suitable amount of electrical energy. In certain embodiments, the power generator is configured to produce 2 MW or more, such as 5 MW or more, such as 10 MW or more, such as 100 MW or more, such as 500 MW or more, such as 1000 MW or more, such as 2 gW or more, and including 10 gW or more. In various instances, power generators include an intake for receiving fuel into the power generator. In some aspects, power generators include at least one conversion element for converting the materials and/or energy received into the intake to electric power. In some instances, power generators include an electrical yield component configured for providing an output of electrical power from the power generator. In various embodiments, power generators include one or more control systems configured for controlling the amount of fuel into an intake and/or for controlling the amount of fuel converted to electric power and/or for controlling the amount of electric power output through the electrical yield component.

In certain instances, power generators include a gas turbine. Gas turbines are discussed herein in their conventional sense to describe a combustion engine configured to compress air and mix the compressed air with the fuel. The mixture is subsequently ignited and passes through the blades of a turbine. Movement of the blades leads to the rotation of a drive shaft. Any suitable gas turbine may be employed, including, but not limited to simple cycle gas turbines, and combined cycle gas turbines. Various gas turbines are described in, for example, U.S. Pat. Nos. 2,488,875; 3,899,882; 4,197,700; 4,845,941; 4,896,499; 4,907,406; 5,724,816; 5,806,298; 6,134,876; 7,124,591; 8,245,493; 8,079,803; 8,261,529 8,661,780; 8,713,946; 8,560,205; 9,097,184; 9,297,316; 9,850,794; 9,903,588; 10,041,680; 10,731,512; the disclosures of which are incorporated by reference herein.

In additional instances, power generators include a gas boiler. Gas boilers are discussed herein in their conventional sense to describe a class of devices that create steam via the combustion of a gas (e.g., a natural gas, such as those described above) and thereby generate power via the rotation of a turbine. Any suitable gas boiler may be employed. In some cases, the gas boiler is a supercritical steam generator operating at supercritical pressure (i.e., above the critical point of a phase equilibrium curve). As such, in some cases, the subject gas boilers operate at pressures that are greater than 3,200 psi or 22 MPa. While it may be argued that supercritical steam generators are not technically boilers because no boiling occurs, supercritical steam generators may nonetheless serve as the subject gas boiler because said supercritical steam generators involve the same principle of operation with respect to the broader category of gas boilers. In some embodiments, gas boilers employed herein involve the use of superheated steam (i.e., steam at a temperature that is higher than its vaporization point). Various gas boilers are described in, for example, U.S. Pat. Nos. 6,820,428; 6,955,051; 8,783,035; 9,874,346; 10,316,700; and U.S. Patent Application Publication No. 2013/0118171; the disclosures of which are incorporated by reference herein.

In certain embodiments the power generator comprises a heat recovery steam generator (HRSG). HRSGs are discussed herein in their conventional sense to describe heat exchangers that recover heat from a heated gas. The HRSG may be used in processes that employ heat that would otherwise be lost to the system. In some embodiments, HRSGs may be employed in a cogeneration process that simultaneously generates electricity and heat energy. In additional embodiments, HRSGs are employed in a combined cycle power generation system where heat engines produce energy from the same heat source. HRSGs of interest include, for example, an economizer, evaporator, superheater and water preheater. Various HRSGs and components thereof are described in, for example, U.S. Pat. Nos. 3,691,760; 4,576,124; 4,976,100; 5,042,247; 5,461,853; 5,379,588; 6,829,898; 7,107,774; 8,075,646; 8,505,309; 8,820,078; 9,074,494; and 9,222,410; the disclosures of which are herein incorporated by reference.

As shown in reaction (I), above, products of exemplary oxidization reactions include CO₂ and H₂O. These products may be referred to collectively as “exhaust”. Following the production of the exhaust, some embodiments of the invention additionally include cooling the exhaust. In some instances, cooling the exhaust involves the use of a condenser. In some instances, the cooling of the exhaust in a condenser produces at least a portion of the water sent to the electrolyzer.

### CO₂ Sequestration

Aspects of the invention additionally include CO₂ separation and/or sequestration. Some embodiments of the invention include separating H₂O from the exhaust first and sequestering the CO₂ from the remaining stream. In other embodiments, CO₂ is sequestered from the exhaust directly, resulting in a CO₂ depleted H₂O stream. Any suitable method of capturing or sequestering CO₂ may be employed. In certain cases, sequestering the CO₂ from the exhaust comprises contacting an aqueous capture liquid with the exhaust under conditions sufficient to produce a CO₂-depleted H₂O stream. By “CO₂-depleted H₂O stream”, it is meant a stream of H₂O (e.g., in liquid and/or gaseous form) from which an amount CO₂ has been removed. The aqueous capture liquid may vary. Examples of aqueous capture liquids include, but are not limited to fresh water to bicarbonate buffered aqueous media. Bicarbonate buffered aqueous media employed in embodiments of the invention include liquid media in which a bicarbonate buffer is present. The bicarbonate buffered aqueous medium may be a naturally occurring or man-made medium, as desired. Naturally occurring bicarbonate buffered aqueous media include, but are not limited to, waters obtained from seas, oceans, lakes, swamps, estuaries, lagoons, brines, alkaline lakes, inland seas, etc. Man-made sources of bicarbonate buffered aqueous media may also vary, and may include brines produced by water desalination plants, and the like. Further details regarding such capture liquids are provided in PCT published application Nos. WO2014/039578; WO 2015/134408; and WO 2016/057709; the disclosures of which applications are herein incorporated by reference.

In embodiments, contact of the CO₂ containing gas and bicarbonate buffered aqueous medium is carried out under conditions sufficient to remove CO₂ from the exhaust, and increase the bicarbonate ion concentration of the aqueous medium to produce a bicarbonate rich product (BRP). By “bicarbonate rich product”, it is meant a composition characterized by high concentrations of bicarbonate ion, where the concentration of bicarbonate ion may, in some instances, be 5,000 ppm or greater, such as 10,000 ppm or greater, including 15,000 ppm or greater. In some instances, the bicarbonate ion in the bicarbonate rich products ranges from 5,000 to 20,000 ppm, such as 7,500 to 15,000 ppm, including 8,000 to 12,000 ppm. In some instances, the overall amount of bicarbonate ion may range from 0.1 wt. % to 30 wt. %, such as 3 to 20 wt. %, including from 10 to 15 wt. %. The pH of the bicarbonate rich product produced upon combination of the CO₂ source and aqueous medium, e.g., as described above, may vary, and in some instances range from 4 to 10, such as 6 to 9 and including 8 to 8.5.

Other CO₂ sequestering protocols that may be employed include alkaline intensive protocols, in which a CO₂ containing gas is contacted with an aqueous medium supplemented with a proton-removing agent (e.g., base). In some cases, the capture liquid has a pH of about 10 or more. Examples of such protocols include, but are not limited to, those described in U.S. Pat. Nos. 8,333,944; 8,177,909; 8,137,455; 8,114,214; 8,062,418; 8,006,446; 7,939,336; 7,931,809; 7,922,809; 7,914,685; 7,906,028; 7,887,694; 7,829,053; 7,815,880; 7,771,684; 7,753,618; 7,749,476; 7,744,761; and 7,735,274; the disclosures of which are herein incorporated by reference.

In some embodiments, an aqueous capture ammonia is contacted with the exhaust under conditions sufficient to produce to produce the CO₂-depleted H₂O stream. The concentration of ammonia in the aqueous capture ammonia may vary, where in some instances the aqueous capture ammonia includes ammonia (NH₃) at a concentration ranging from 10 ppm to 350,000 ppm NH₃, such as 10 to 10,000 ppm, or 10 to 1,000 ppm, or 10 to 5,000 ppm, or 10 to 8,000 ppm, or 10 to 10,000 ppm, or 100 to 100,000 ppm, or 100 to 10,000 ppm, or 100 to 50,000 ppm, or 100 to 80,000 ppm, or 100 to 100,000 ppm, or 1,000 to 350,000 ppm, or 1,000 to 50,000 ppm, or 1,000 to 80,000 ppm, or 1,000 to 100,000 ppm, or 1,000 to 200,000 ppm, or 1,000 to 350,000 ppm, or such as from 6,000 to 85,000 ppm, and including 8,000 to 50,000 ppm. The aqueous capture ammonia may include any convenient water. Waters of interest from which the aqueous capture ammonia may be produced include, but are not limited to, freshwaters, seawaters, brine waters, reclaimed or recycled waters, produced waters and waste waters. The pH of the aqueous capture ammonia may vary, ranging in some instances from 9.0 to 13.5, such as 9.0 to 13.0, including 10.5 to 12.5. Further details regarding aqueous capture ammonias of interest are provided in PCT published application No. WO 2017/165849; the disclosure of which is herein incorporated by reference.

The exhaust, e.g., as described above, may be contacted with the aqueous capture liquid (e.g., bicarbonate buffered aqueous medium, aqueous capture ammonia, etc.) using any convenient protocol. For example, contact protocols of interest include, but are not limited to: direct contacting protocols, e.g., bubbling the gas through a volume of the aqueous medium, concurrent contacting protocols, i.e., contact between unidirectionally flowing gaseous and liquid phase streams, countercurrent protocols, i.e., contact between oppositely flowing gaseous and liquid phase streams, and the like. Contact may be accomplished through use of infusers, bubblers, fluidic Venturi reactors, spargers, gas filters, sprays, trays, scrubbers, absorbers or packed column reactors, and the like, as may be convenient. In some instances, the contacting protocol may use a conventional absorber or an absorber froth column, such as those described in U.S. Pat. Nos. 7,854,791; 6,872,240; and 6,616,733; and in United States Patent Application Publication US-2012-0237420-A1; the disclosures of which are herein incorporated by reference. The process may be a batch or continuous process. In some instances, a regenerative froth contactor (RFC) may be employed to contact the CO₂ containing gas with the aqueous capture liquid, e.g., aqueous capture ammonia. In some such instances, the RFC may use a catalyst (such as described elsewhere), e.g., a catalyst that is immobilized on/to the internals of the RFC. Further details regarding a suitable RFC are found in U.S. Pat. No. 9,545,598, the disclosure of which is herein incorporated by reference.

In some instances, the exhaust is contacted with the liquid using a microporous membrane contactor. Microporous membrane contactors of interest include a microporous membrane present in a suitable housing, where the housing includes a gas inlet and a liquid inlet, as well a gas outlet and a liquid outlet. The contactor is configured so that the gas and liquid contact opposite sides of the membrane in a manner such that molecule may dissolve into the liquid from the gas via the pores of the microporous membrane. The membrane may be configured in any convenient format, where in some instances the membrane is configured in a hollow fiber format. Hollow fiber membrane reactor formats which may be employed include, but are not limited to, those described in U.S. Pat. Nos. 7,264,725; 6,872,240 and 5,695,545; the disclosures of which are herein incorporated by reference. In some instances, the microporous hollow fiber membrane contactor that is employed is a hollow fiber membrane contactor, which membrane contactors include polypropylene membrane contactors and polyolefin membrane contactors.

In certain cases, contact between the capture liquid and the exhaust occurs under conditions such that a substantial portion of the CO₂ goes into solution, e.g., to produce bicarbonate ions. By “substantial portion” is meant 10% or more, such as 50% or more, including 80% or more.

The temperature of the capture liquid that is contacted with the exhaust may vary. In some instances, the temperature ranges from −1.4 to 100° C., such as 20 to 80° C. and including 40 to 70° C. In some instances, the temperature may range from −1.4 to 50° C. or higher, such as from −1.1 to 45° C. or higher. In some instances, cooler temperatures are employed, where such temperatures may range from −1.4 to 4° C., such as −1.1 to 0° C. In some instances, warmer temperatures are employed. For example, the temperature of the capture liquid in some instances may be 25° C. or higher, such as 30° C. or higher, and may in some embodiments range from 25 to 50° C., such as 30 to 40° C.

The exhaust and the capture liquid are contacted at a pressure suitable for production of a desired CO₂ charged liquid. In some instances, the pressure of the contact conditions is selected to provide for optimal CO₂ absorption, where such pressures may range from 0.1 ATM to 100 ATM, such as 0.1 to 50 ATM, e.g., 20-30 ATM or 0.1 ATM to 10 ATM. Where contact occurs at a location that is naturally at 1 ATM, the pressure may be increased to the desired pressure using any convenient protocol. In some instances, contact occurs where the optimal pressure is present, e.g., at a location under the surface of a body of water, such as an ocean or sea.

In some cases, sequestering the CO₂ from the exhaust comprises contacting an aqueous capture liquid with the exhaust under conditions sufficient to produce an aqueous carbonate. In embodiments where the exhaust is contacted with an aqueous capture ammonia, contact is carried out in manner sufficient to produce an aqueous ammonium carbonate. The aqueous ammonium carbonate may vary, where in some instances the aqueous ammonium carbonate comprises at least one of ammonium carbonate and ammonium bicarbonate and in some instances comprises both ammonium carbonate and ammonium bicarbonate. The aqueous ammonium bicarbonate may be viewed as a DIC containing liquid. As such, in charging the aqueous capture ammonia with CO₂, a CO₂ containing gas may be contacted with CO₂ capture liquid under conditions sufficient to produce dissolved inorganic carbon (DIC) in the CO₂ capture liquid, i.e., to produce a DIC containing liquid. The DIC is the sum of the concentrations of inorganic carbon species in a solution, represented by the equation: DIC=[CO₂*]+[HCO₃⁻]+[CO₃²⁻], where [CO₂*] is the sum of carbon dioxide ([CO₂]) and carbonic acid ([H₂CO₃]) concentrations, [HCO₃⁻] is the bicarbonate concentration (which includes ammonium bicarbonate) and [CO₃²⁻] is the carbonate concentration (which includes ammonium carbonate) in the solution. The DIC of the aqueous media may vary, and in some instances may be 3 ppm to 168,000 ppm carbon (C), such as 3 to 1,000 ppm, or 3 to 100 ppm, or 3 to 500 ppm, or 3 to 800 ppm, or 3 to 1,000 ppm, or 100 to 10,000 ppm, or 100 to 1,000 ppm, or 100 to 5,000 ppm, or 100 to 8,000 ppm, or 100 to 10,000 ppm, or 1,000 to 50,000 ppm, or 1,000 to 8,000 ppm, or 1,000 to 15,000 ppm, or 1,000 to 30,000 ppm, or 5,000 to 168,000 ppm, or 5,000 to 25,000 ppm, or such as from 6,000 to 65,000 ppm, and including 8,000 to 95,000 ppm carbon (C). The amount of CO₂ dissolved in the liquid may vary, and in some instances ranges from 0.05 to 40 mM, such as 1 to 35 mM, including 25 to 30 mM. The pH of the resultant DIC containing liquid may vary, ranging in some instances from 4 to 12, such as 6 to 11 and including 7 to 11, e.g., 8 to 9.5.

Where desired, the exhaust is contacted with the capture liquid in the presence of a catalyst (i.e., an absorption catalyst, either hetero- or homogeneous in nature) that mediates the conversion of CO₂ to bicarbonate. Of interest as absorption catalysts are catalysts that, at pH levels ranging from 8 to 10, increase the rate of production of bicarbonate ions from dissolved CO₂. The magnitude of the rate increase (e.g., as compared to control in which the catalyst is not present) may vary, and in some instances is 2-fold or greater, such as 5-fold or greater, e.g., 10-fold or greater, as compared to a suitable control. Further details regarding examples of suitable catalysts for such embodiments are found in U.S. Pat. No. 9,707,513, the disclosure of which is herein incorporated by reference.

In some embodiments, the resultant aqueous ammonium carbonate is a two-phase liquid which includes droplets of a liquid condensed phase (LCP) in a bulk liquid, e.g., bulk solution. By “liquid condensed phase” or “LCP” is meant a phase of a liquid solution which includes bicarbonate ions wherein the concentration of bicarbonate ions is higher in the LCP phase than in the surrounding, bulk liquid. LCP droplets are characterized by the presence of a meta-stable bicarbonate-rich liquid precursor phase in which bicarbonate ions associate into condensed concentrations exceeding that of the bulk solution and are present in a non-crystalline solution state. The LCP contains all of the components found in the bulk solution that is outside of the interface. However, the concentration of the bicarbonate ions is higher than in the bulk solution. In those situations where LCP droplets are present, the LCP and bulk solution may each contain ion-pairs and pre-nucleation clusters (PNCs). When present, the ions remain in their respective phases for long periods of time, as compared to ion-pairs and PNCs in solution. Further details regarding LCP containing liquids are provided in U.S. Pat. No. 9,707,513; the disclosure of which is herein incorporated by reference.

In those embodiments that employ an aqueous capture ammonia, combination of a cation source with the aqueous ammonium carbonate (e.g., as described in greater detail below) produces a solid CO₂ sequestering carbonate and an aqueous ammonium salt. The produced aqueous ammonium salt may vary with respect to the nature of the anion of the ammonium salt, where specific ammonium salts that may be present in the aqueous ammonium salt include, but are not limited to, ammonium chloride, ammonium acetate, ammonium sulfate, ammonium nitrate, etc.

Aspects of the invention may further include regenerating an aqueous capture ammonia, e.g., as described above, from the aqueous ammonium salt. By regenerating an aqueous capture ammonium is meant processing the aqueous ammonium salt in a manner sufficient to generate ammonia from the aqueous ammonium salt. The percentage of input ammonium salt that is converted to ammonia during this regeneration step may vary, ranging in some instances from 20 to 80%, such as 35 to 55%.

Ammonia may be regenerated from an aqueous ammonium salt in this regeneration step using any convenient regeneration protocol. In some instances, a distillation protocol is employed. While any convenient distillation protocol may be employed, in some embodiments the employed distillation protocol includes heating the aqueous ammonium salt in the presence of an alkalinity source to produce a gaseous ammonia/water product, which may then be condensed to produce a liquid aqueous capture ammonia. Ammonia regeneration is described in, for example, U.S. Patent Application No. US 2020/0129916; the disclosure of which is incorporated by reference herein.

The alkalinity source may vary, so long as it is sufficient to convert ammonium in the aqueous ammonium salt to ammonia. Any convenient alkalinity source may be employed. Alkalinity sources that may be employed in this regeneration step include chemical agents. Chemical agents that may be employed as alkalinity sources include, but are not limited to, hydroxides, organic bases, super bases, oxides, and carbonates. Hydroxides include chemical species that provide hydroxide anions in solution, including, for example, sodium hydroxide (NaOH), potassium hydroxide (KOH), calcium hydroxide (Ca(OH)₂), or magnesium hydroxide (Mg(OH)₂). Organic bases are carbon-containing molecules that are generally nitrogenous bases including primary amines such as methyl amine, secondary amines such as diisopropylamine, tertiary such as diisopropylethylamine, aromatic amines such as aniline, heteroaromatics such as pyridine, imidazole, and benzimidazole, and various forms thereof. Super bases suitable for use as proton-removing agents include sodium ethoxide, sodium amide (NaNH₂), sodium hydride (NaH), butyl lithium, lithium diisopropylamide, lithium diethylamide, and lithium bis(trimethylsilyl)amide. Oxides including, for example, calcium oxide (CaO), magnesium oxide (MgO), strontium oxide (SrO), beryllium oxide (BeO), and barium oxide (BaO) are also suitable proton-removing agents that may be used.

Also of interest as alkalinity sources are silica sources. The source of silica may be pure silica or a composition that includes silica in combination with other compounds, e.g., minerals, so long as the source of silica is sufficient to impart desired alkalinity. In some instances, the source of silica is a naturally occurring source of silica. Naturally occurring sources of silica include silica containing rocks, which may be in the form of sands or larger rocks. Where the source is larger rocks, in some instances the rocks have been broken down to reduce their size and increase their surface area. Of interest are silica sources made up of components having a longest dimension ranging from 0.01 mm to 1 meter, such as 0.1 mm to 500 cm, including 1 mm to 100 cm, e.g., 1 mm to 50 cm. The silica sources may be surface treated, where desired, to increase the surface area of the sources. A variety of different naturally occurring silica sources may be employed. Naturally occurring silica sources of interest include, but are not limited to, igneous rocks, which rocks include: ultramafic rocks, such as Komatiite, Picrite basalt, Kimberlite, Lamproite, Peridotite; mafic rocks, such as Basalt, Diabase (Dolerite) and Gabbro; intermediate rocks, such as Andesite and Diorite; intermediate felsic rocks, such as Dacite and Granodiorite; and Felsic rocks, such as Rhyolite, Aplite-Pegmatite and Granite. Also of interest are man-made sources of silica. Man-made sources of silica include, but are not limited to, waste streams such as: mining wastes; fossil fuel burning ash; slag, e.g. iron slag, phosphorous slag; cement kiln waste; oil refinery/petrochemical refinery waste, e.g. oil field and methane seam brines; coal seam wastes, e.g. gas production brines and coal seam brine; paper processing waste; water softening, e.g. ion exchange waste brine; silicon processing wastes; agricultural waste; metal finishing waste; high pH textile waste; and caustic sludge. Mining wastes include any wastes from the extraction of metal or another precious or useful mineral from the earth. Wastes of interest include wastes from mining to be used to raise pH, including: red mud from the Bayer aluminum extraction process; the waste from magnesium extraction for sea water, e.g. at Moss Landing, Calif.; and the wastes from other mining processes involving leaching. Ash from processes burning fossil fuels, such as coal fired power plants, create ash that is often rich in silica. In some embodiments, ashes resulting from burning fossil fuels, e.g. coal fired power plants, are provided as silica sources, including fly ash, e.g., ash that exits out the smokestack, and bottom ash. Additional details regarding silica sources and their use are described in U.S. Pat. No. 9,714,406; the disclosure of which is herein incorporated by reference.

In some embodiments of the invention, ash is employed as an alkalinity source. Of interest in certain embodiments is use of a coal ash as the ash. The coal ash as employed in this invention refers to the residue produced in power plant boilers or coal burning furnaces, for example, chain grate boilers, cyclone boilers and fluidized bed boilers, from burning pulverized anthracite, lignite, bituminous or sub-bituminous coal. Such coal ash includes fly ash which is the finely divided coal ash carried from the furnace by exhaust or flue gases; and bottom ash which collects at the base of the furnace as agglomerates.

Fly ashes are generally highly heterogeneous, and include of a mixture of glassy particles with various identifiable crystalline phases such as quartz, mullite, and various iron oxides. Fly ashes of interest include Type F and Type C fly ash. The Type F and Type C fly ashes referred to above are defined by CSA Standard A23.5 and ASTM C618. The chief difference between these classes is the amount of calcium, silica, alumina, and iron content in the ash. The chemical properties of the fly ash are largely influenced by the chemical content of the coal burned (i.e., anthracite, bituminous, and lignite). Fly ashes of interest include substantial amounts of silica (silicon dioxide, SiO₂) (both amorphous and crystalline) and lime (calcium oxide, CaO, magnesium oxide, MgO).

The burning of harder, older anthracite and bituminous coal typically produces Class F fly ash. Class F fly ash is pozzolanic in nature, and contains less than 10% lime (CaO). Fly ash produced from the burning of younger lignite or subbituminous coal, in addition to having pozzolanic properties, also has some self-cementing properties. In the presence of water, Class C fly ash will harden and gain strength over time. Class C fly ash generally contains more than 20% lime (CaO). Alkali and sulfate (SO₄) contents are generally higher in Class C fly ashes.

Fly ash material solidifies while suspended in exhaust gases and is collected using various approaches, e.g., by electrostatic precipitators or filter bags. Since the particles solidify while suspended in the exhaust gases, fly ash particles are generally spherical in shape and range in size from 0.5 μm to 100 μm. Fly ashes of interest include those in which at least about 80%, by weight comprises particles of less than 45 microns. Also of interest in certain embodiments of the invention is the use of highly alkaline fluidized bed combustor (FBC) fly ash.

Also of interest in embodiments of the invention is the use of bottom ash. Bottom ash is formed as agglomerates in coal combustion boilers from the combustion of coal. Such combustion boilers may be wet bottom boilers or dry bottom boilers. When produced in a wet or dry bottom boiler, the bottom ash is quenched in water. The quenching results in agglomerates having a size in which 90% fall within the particle size range of 0.1 mm to 20 mm, where the bottom ash agglomerates have a wide distribution of agglomerate size within this range. The main chemical components of a bottom ash are silica and alumina with lesser amounts of oxides of Fe, Ca, Mg, Mn, Na and K, as well as sulphur and carbon.

Also of interest in certain embodiments is the use of volcanic ash as the ash. Volcanic ash is made up of small tephra, i.e., bits of pulverized rock and glass created by volcanic eruptions, less than 2 millimetres in diameter.

In one embodiment of the invention, cement kiln dust (CKD) is employed as an alkalinity source. The nature of the fuel from which the ash and/or CKD were produced, and the means of combustion of said fuel, will influence the chemical composition of the resultant ash and/or CKD. Thus ash and/or CKD may be used as a portion of the means for adjusting pH, or the sole means, and a variety of other components may be utilized with specific ashes and/or CKDs, based on chemical composition of the ash and/or CKD.

In certain embodiments of the invention, slag is employed as an alkalinity source. The slag may be used as a as the sole pH modifier or in conjunction with one or more additional pH modifiers, e.g., ashes, etc. Slag is generated from the processing of metals, and may contain calcium and magnesium oxides as well as iron, silicon and aluminum compounds. In certain embodiments, the use of slag as a pH modifying material provides additional benefits via the introduction of reactive silicon and alumina to the precipitated product. Slags of interest include, but are not limited to, blast furnace slag from iron smelting, slag from electric-arc or blast furnace processing of steel, copper slag, nickel slag and phosphorus slag.

As indicated above, ash (or slag in certain embodiments) is employed in certain embodiments as the sole way to modify the pH of the water to the desired level. In yet other embodiments, one or more additional pH modifying protocols is employed in conjunction with the use of ash.

Also of interest in certain embodiments is the use of other waste materials, e.g., demolished or recycled or returned concretes or mortars, as an alkalinity source. When employed, the concrete dissolves releasing sand and aggregate which, where desired, may be recycled to the carbonate production portion of the process. Use of demolished and/or recycled concretes or mortars is further described below.

Of interest in certain embodiments are mineral alkalinity sources. The mineral alkalinity source that is contacted with the aqueous ammonium salt in such instances may vary, where mineral alkalinity sources of interest include, but are not limited to: silicates, carbonates, fly ashes, slags, limes, cement kiln dusts, etc., e.g., as described above. In some instances, the mineral alkalinity source comprises a rock, e.g., as described above.

In some aspects of the invention, the methods further include providing calcium and/or alkalinity into one or more steps of the process from demolished or returned concrete geomass for carbon sequestration and utilization through calcium carbonate mineralization and use of the residual concrete as a favorable aggregate in new concrete after the partial dissolution of recycled concrete geomass material. Geomass or geomass material, as used herein, refers to concrete that has been demolished after its service life or other reasons. Though generally, geomass is most commonly a waste product from industry, geomass may also refer to primary, secondary, tertiary, byproduct or other product from industry. Some example general trade names of geomass materials from industry may include mine tailings, mining dust, sand, baghouse fines, soil dust, dust, cement kiln dust, slag, steel slag, boiler slag, coal combustion residue, ash, fly ash, slurry, lime slurry, lime, kiln dust, kiln fines, residue, bauxite residue, demolished concrete, recycled concrete, recycled mortar, recycled cement, demolished building materials, recycled building materials, recycled aggregate, etc. Geomass materials typically have compositions that contain metal oxides, as crystalline or amorphous phases, such as sodium oxide, potassium oxide, or other alkali metal oxide, magnesium oxide, calcium oxide, or other alkaline earth metal oxide, manganese oxide, copper oxide, or other transition metal oxide, zinc oxide or any other metal oxide or derivative thereof, or metal oxides present in crystalline form in simple or complex minerals or as amorphous phases of metal oxides or derivatives thereof or as a combination of any of the above.

While the temperature to which the aqueous ammonium salt is heated in these embodiments may vary, in some instances the temperature ranges from 25 to 200, such as 25 to 185° C. The heat employed to provide the desired temperature may be obtained from any convenient source, including steam, a waste heat source, such as flue gas waste heat, etc.

Distillation may be carried out at any pressure. Where distillation is carried out at atmospheric pressure, the temperature at which distillation is carried out may vary, ranging in some instances from 50 to 120, such as 60 to 100, e.g., from 70 to 90° C. In some instances, distillation is carried out at a sub atmospheric pressure. While the pressure in such embodiments may vary, in some instances the sub-atmospheric pressure ranges from 1 to 14.7 psia, such as from 2 to 6 psia. Where distillation is carried out at sub-atmospheric pressure, the distillation may be carried out at a reduced temperature as compared to embodiments that are performed at atmospheric pressure. While the temperature may vary in such instances as desired, in some embodiments where a sub atmospheric pressure is employed, the temperature ranges from 15 to 110, such as 25 to 50° C. Of interest in sub-atmospheric pressure embodiments is the use of a waste heat for some, if not all, of the heat employed during distillation. Waste heat sources of that may be employed in such instances include, but are not limited to: flue gas, heat of absorption generated by CO₂ capture and resultant ammonium carbonate production; and a cooling liquid (such as from a co-located source of CO₂ containing gas, such as a power plant, factory etc., e.g., as described above), and combinations thereof.

Aqueous capture ammonia regeneration may also be achieved using an electrolysis mediated protocol, in which a direct electric current is introduced into the aqueous ammonium salt to regenerate ammonia. Any convenient electrolysis protocol may be employed. Examples of electrolysis protocols that may be adapted for regeneration of ammonia from an aqueous ammonium salt may employed one or more elements from the electrolysis systems described in United States Application Publication Nos. 20060185985 and 20080248350, as well as published PCT Application Publication No. WO 2008/018928; the disclosures of which are hereby incorporated by reference.

The resultant regenerated aqueous capture ammonia may vary, e.g., depending on the particular regeneration protocol that is employed. In some instances, the regenerated aqueous capture ammonia includes ammonia (NH₃) at a concentration ranging from 0.1 M to 25 M, such as from 4 to 20 M, including from 12.0 to 16.0 M, as well as any of the ranges provided for the aqueous capture ammonia provided above. The pH of the aqueous capture ammonia may vary, ranging in some instances from 10.0 to 13.0, such as 10.0 to 12.5.

In some instances, the methods further include contacting the regenerated aqueous capture ammonia with exhaust, e.g., as described above, under conditions sufficient to produce an aqueous ammonium carbonate. In other words, the methods may include recycling the regenerated ammonia into the process. In such instances, the regenerated aqueous capture ammonia may be used as the sole capture liquid, or combined with another liquid, e.g., make up water, to produce an aqueous capture ammonia suitable for use as a CO₂ capture liquid. Where the regenerated aqueous ammonia is combined with additional water, any convenient water may be employed. Waters of interest from which the aqueous capture ammonia may be produced include, but are not limited to, freshwaters, seawaters, brine waters, produced waters and waste waters.

### Electrolysis

As discussed above, aspects of the subject methods include electrolyzing H₂O from the CO₂-depleted H₂O stream using the generated electrical energy to synthesize gaseous O₂ and the H₂. “Electrolysis” is referred to in its conventional sense to refer to a chemical reaction that is driven by an electric current. In the present case, the reaction that is driven is reaction (VI), below:

H₂O→H₂+½O₂ (VI)

Electrolysis involves the use of an anode and cathode separated by an electrolyte. Electrolyzers suitable for use in the subject methods vary and generally differ in the type of electrolyte and the ionic species conducted. In some cases, electrolyzing the generated H₂O comprises alkaline water electrolysis (AWE). In AWE, the electrodes operate in a liquid alkaline electrolyte solution of potassium hydroxide (KOH) or sodium hydroxide (NaOH). In certain cases, AWE electrolyzers include a diaphragm or membrane separating the produced O₂ and H₂ that is configured to transport hydroxide ions (OH⁻) from one electrode to the other. Alkaline water electrolyzers are described in, for example, U.S. Patent Publication Nos. 2020/0039848; 2020/0102663; 2021/0115573; and U.S. Pat. Nos. 8,632,672; 9,683,300; 10,619,253; 11,220,755; the disclosures of which are incorporated by reference herein.

In certain cases, electrolyzing the generated H₂O comprises proton exchange membrane (PEM) electrolysis, sometimes known as polymer electrolyte membrane electrolysis. A PEM is a semipermeable membrane that is permeable to protons. The PEM additionally acts as an electronic insulator and a barrier between the produced hydrogen and oxygen. In certain cases, PEMs are produced from ionomers. In some cases, PEMs are produced from pure polymer materials. In other cases, PEMs are produced from composite membranes. In still other cases, PEMs include materials embedded in a polymer matrix. In some embodiments, the PEM includes a fluoropolymer (e.g., a sulfonated tetrafluoroethylene based fluoropolymer-copolymer). PEM electrolyzers are described in, for example, U.S. Patent Publication Nos. 2013/0092549; 2020/0240023; and U.S. Pat. Nos. 7,229,534; 7,270,908; 8,182,659; 10,233,550; the disclosures of which are incorporated by reference herein.

In some versions, electrolyzing the generated H₂O comprises solid oxide electrolysis (SOE). In embodiments, SOE electrolyzers operate at temperatures ranging from 650-1000° C. Oxygen ions (O²⁻) pass through a solid oxide electrolyte to the anode where said ions are oxidized to form O₂. Any convenient solid oxide electrolyte may be employed. In certain cases, the solid oxide electrolyte is a dense ionic conductor, such as a dense ionic conductor consisting of ZrO₂ doped with Y₂O₃. In some cases, the solid oxide electrolyte includes Scandia stabilized zirconia (ScSZ), ceria based electrolytes, lanthanum gallate materials; or the like, and combinations thereof. Cathode materials include; but are not limited to, Y₂O₃ doped with nickel, lanthanum strontium manganese, lanthanum strontium manganese doped with scandium, or the like, and combinations thereof. Anode materials include, but are not limited to, lanthanum strontium manganate, manganate impregnated with Gd-doped CeO₂, or the like, and combinations thereof. SOE electrolyzers are described in, for example, U.S. Pat. No. 7,976,686; the disclosure of which is herein incorporated by reference.

Certain embodiments of the method additionally include providing heat to the electrolysis reaction. Because the water electrolysis reaction is endothermic, heat is consumed in order to synthesize H₂ and O₂. Accordingly, methods may include supplying heat produced during the oxidization of the fuel to the electrolysis reaction, e.g., via a heat exchanger. For example, select embodiments of the methods include supplying heat from the exhaust to the electrolysis reaction.

In embodiments, methods additionally include obtaining additional purified water, e.g., to supplement the H₂O in the CO₂-depleted H₂O being electrolyzed. The additional purified water may be obtained from any convenient source. In some cases, the additional purified water is obtained using a reverse osmosis protocol. Reverse osmosis employs pressure and/or one or more semipermeable membranes to purify water. In certain versions of reverse osmosis, water is passed through one or more semipermeable membranes in order to remove salt and/or minerals and/or other impurities therefrom. In other embodiments, the additional purified water is obtained using a distillation protocol. Such protocols may involve boiling water (e.g., salt water) and collecting water (e.g., water vapor) having a significantly reduced or eliminated salt and/or other impurity concentration. Some embodiments of the method include boiling water at less than atmospheric pressure. In some versions, methods include multistage flash distillation. As such, methods may include one or more processes that distill water (e.g., seawater) by flashing an amount of water into steam in multiple stages of concurrent heat exchangers.

As discussed above, electrical energy obtained from the power generator is employed to apply electric current for electrolysis. In certain cases, additional electrical energy (i.e., energy in addition to that obtained from the subject power generator) is employed. The additional electrical energy may be employed for electrolysis and/or another part of the method, as necessary or desired. Any suitable source of electrical energy may be employed as the additional electrical energy. Sources of interest include, but are not limited to, fossil fuels (e.g., coal, oil, and/or natural gas), nuclear power or green (e.g., renewable) power sources. Where the additional electrical energy is obtained from a green power source, the green power source may include, for example, a wind power source, a hydroelectric power source, a solar power source, a hydrogen power source, or the like.

### Air Separation

Embodiments of the subject methods additionally include obtaining an O₂-containing gas from the surrounding atmosphere for oxidizing the fuel. By “O₂ containing gas” it is meant a gaseous composition that contains O₂ at the minimum, but may optionally include another gas (e.g., CO₂, N₂, Ar, etc.). The O₂-containing gas discussed herein is supplied to the power generator such that the O₂ in said gas is consumed by the combustion reaction occurring therein. The O₂-containing gas may be obtained via any convenient protocol. In embodiments, the method comprises obtaining the O₂-containing gas via an air separation unit (ASU), a system configured to separate air into its components. In some cases, obtaining the O₂-containing gas include fractional distillation. For example, in some instances, obtaining the O₂-containing gas includes a cryogenic distillation process, e.g., where gasses are first cooled to the point of liquification and then selectively distilled at their respective boiling temperatures. In some cases, the O₂-containing gas is obtained via a pressure swing adsorption (PSA) process. PSA operates by separating gasses based on their affinity for an adsorbent material. PSA generally operates under high pressure. In some instances, the O₂-containing gas is obtained via a vacuum pressure swing adsorption (VPSA) process. VPSA differs from PSA in that it segregates gases at ambient pressure, but subsequently employs a vacuum to regenerate the adsorbent material. Protocols for obtaining the O₂-containing gas may be adapted from, for example, U.S. Pat. Nos. 4,375,367; 4,439,220; 4,594,085; 4,704,148; 4,810,265; 5,518,526; 5,123,249; 5,232,473; 5,412,953; 5,702,504; 5,758,515; 5,983,666; 6,096,115; 6,010,555; 6,156,101; 6,183,538; 6,295,836; 6,811,590; 6,929,683; 7,396,387; 7,651,549; 7,854,793; 8,128,734; 9,038,413; 9,976,803; 10,480,853; and 10,458,702; the disclosures of which are incorporated by reference herein.

As discussed above, the gaseous O₂ synthesized via electrolysis oxidizes at least a portion of the fuel. In some embodiments where an O₂-containing gas is obtained, methods include supplying both synthesized O₂ and the O₂-containing gas to the power generator for oxidization. In these embodiments, the ratio of synthesized gaseous O₂ to the obtained O₂-containing gas oxidizing the fuel may vary. In certain embodiments, the ratio of synthesized gaseous O₂ to the obtained O₂-containing gas oxidizing the fuel ranges from 99:1 to 1:99, such as 90:10 to 10:90, such as 80:20 to 20:80, such as 70:30 to 30:70, such as 60:40 to 40:60, and including 55:45 to 45:55. In certain cases, the ratio of synthesized gaseous O₂ to the obtained O₂-containing gas oxidizing the fuel is (or approximates) 50:50.

In some embodiments, the O₂-containing gas further comprises CO₂. In such embodiments, methods include obtaining CO₂ from the atmosphere (e.g., directly from the atmosphere) in addition to the exhaust. CO₂. may be sequestered from the atmosphere via any convenient protocol. In certain cases, obtaining the CO₂ in the O₂-containing gas comprises direct air capture (DAC). DAC involves a class of technologies capable of separating carbon dioxide CO₂ directly from ambient air. A DAC system is any system that captures CO₂ directly from air and generates a product gas that includes CO₂ at a higher concentration than that of the air that is input into the DAC system. The DAC product gas that is contacted with the aqueous capture liquid may be produced by any convenient DAC system. DAC systems are systems that extract CO₂ from the air using media that binds to CO₂ but not to other atmospheric chemicals (such as nitrogen and oxygen). As air passes over the CO₂ binding medium, CO₂ “sticks” to the binding medium. In response to a stimulus, e.g., heat, humidity, etc., the bound CO₂ may then be released from the binding medium resulting the production of a gaseous CO₂ containing product. DAC systems of interest include, but are not limited to: hydroxide based systems; CO₂ sorbent/temperature swing based systems, and CO₂ sorbent/temperature swing based systems. In some instances, the DAC system is a hydroxide based system, in which CO₂ is separated from air by contacting the air with is an aqueous hydroxide liquid. Examples of hydroxide based DAC systems include, but are not limited to, those described in PCT published application Nos. WO/2009/155539; WO/2010/022339; WO/2013/036859; and WO/2013/120024; the disclosures of which are herein incorporated by reference. In some instances, the DAC system is a CO₂ sorbent based system, in which CO₂ is separated from air by contacting the air with sorbent, such as an amine sorbent, followed by release of the sorbent captured CO₂ by subjecting the sorbent to one or more stimuli, e.g., change in temperature, change in humidity, etc. Examples of such DAC systems include, but are not limited to, those described in PCT published application Nos. WO/2005/108297; WO/2006/009600; WO/2006/023743; WO/2006/036396; WO/2006/084008; WO/2007/016271; WO/2007/114991; WO/2008/042919; WO/2008/061210; WO/2008/131132; WO/2008/144708; WO/2009/061836; WO/2009/067625; WO/2009/105566; WO/2009/149292; WO/2010/019600; WO/2010/022399; WO/2010/107942; WO/2011/011740; WO/2011/137398; WO/2012/106703; WO/2013/028688; WO/2013/075981; WO/2013/166432; WO/2014/170184; WO/2015/103401; WO/2015/185434; WO/2016/005226; WO/2016/037668; WO/2016/162022; WO/2016/164563; WO/2016/161998; WO/2017/184652; and WO/2017/009241; the disclosures of which are herein incorporated by reference. In some cases where an ASU is employed, the ASU may operate via DAC.

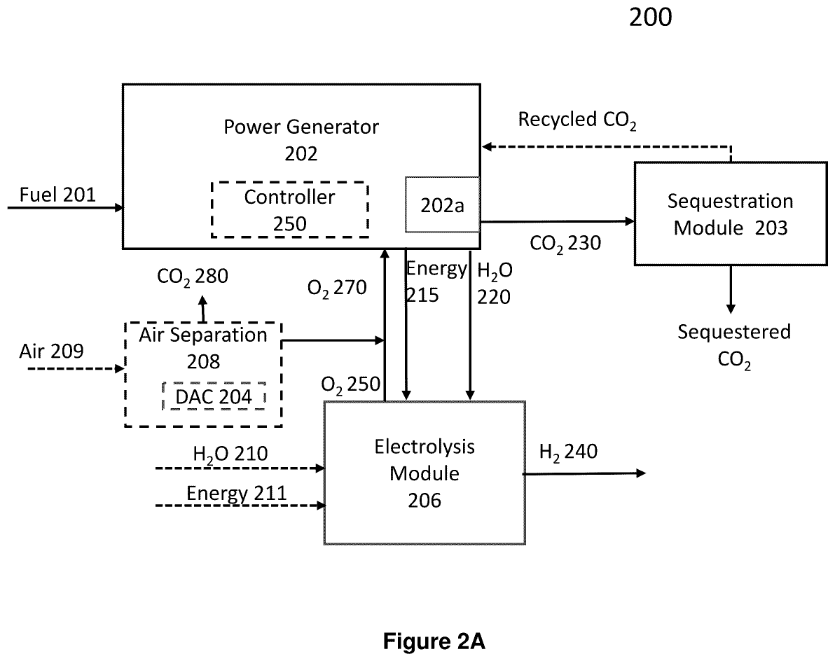

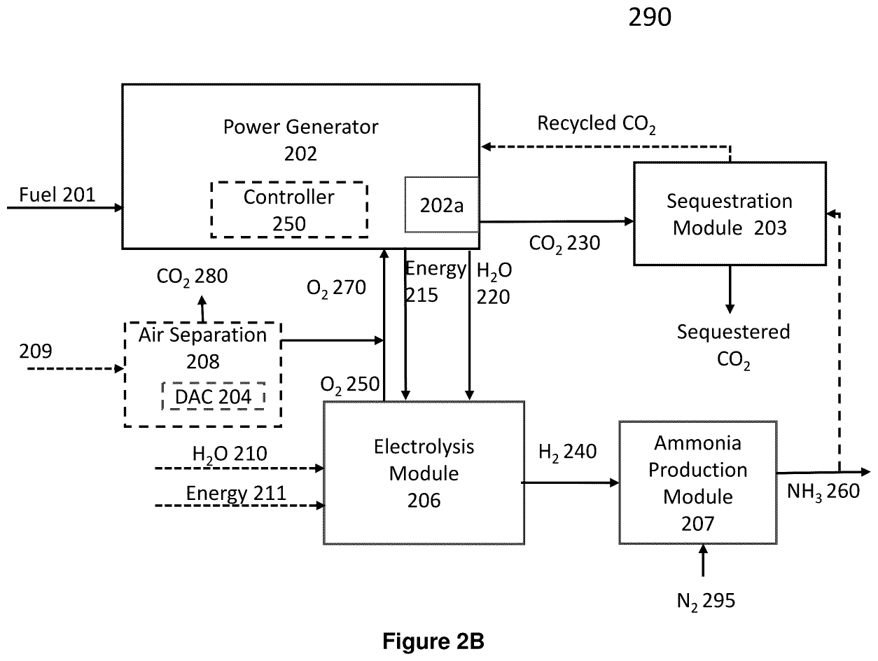

FIG. 2A-2B present embodiments of the claimed invention. In some embodiments where CO₂ 280 is obtained from the atmosphere (e.g., via DAC), methods additionally include sequestering the CO₂. Any convenient protocol for CO₂ sequestration may be employed, including those described above. In certain cases, sequestering the CO₂ 280 in the O₂-containing gas 209 includes combining the CO₂ 280 obtained from the atmosphere with the CO₂ 230 obtained from the exhaust such that the CO₂ from both sources is sequestered together and/or simultaneously and/or using the same sequestration process 203. For example, in certain cases, methods include providing CO₂ 280 obtained from the atmosphere to the sequestration process 203, e.g., via a gaseous connection that runs from a DAC apparatus 204 directly to the sequestration process 203. In other cases, the method comprises combining the CO₂ 280 in the O₂-containing gas 209 with the fuel. In such cases, the CO₂ 280 is not combusted or otherwise transformed in the combustion reaction and is pooled with the CO₂ 230 produced in said combustion reaction. CO₂ from both sources, that is CO₂ 280 and CO₂ 230, is subsequently provided to the CO₂ sequestration process 203, where it is sequestered by one or more of the protocols provided above.

In some versions, methods include obtaining gaseous nitrogen (N₂). In such versions, the gaseous N₂ may be obtained via any convenient protocol. For example, in certain embodiments, methods include obtaining gaseous N₂ concurrently with the O₂-containing gas. For example, in embodiments where an ASU is employed, said ASU may be configured to produce the O₂-containing gas 209 and N₂. In other cases, methods include two separate ASUs. One may be configured to obtain the O₂-containing gas, and the other may be configured to obtain N₂.

In some embodiments involving air separation (e.g., via an ASU), aspects of the methods include producing purified gas streams. Put another way, in addition to or instead of producing an O₂-containing gaseous mixture having multiple gases (e.g., O₂ and CO₂), methods may include producing separated gaseous streams, e.g., where each separated gaseous stream possesses a single (e.g., purified) gas. In some such instances, methods include producing one or more of a separated O₂ stream, a separated CO₂ stream, and a separated N₂ stream.

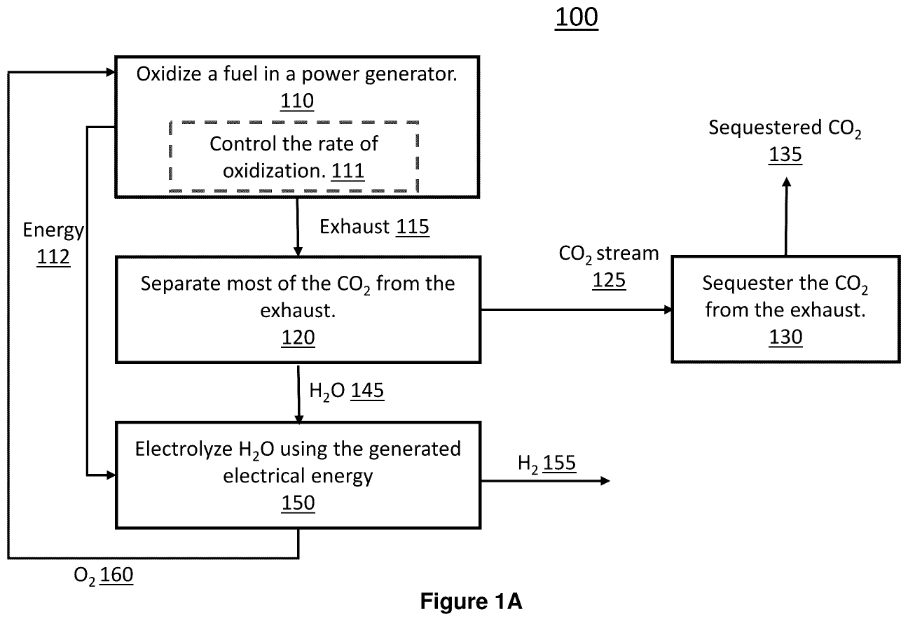

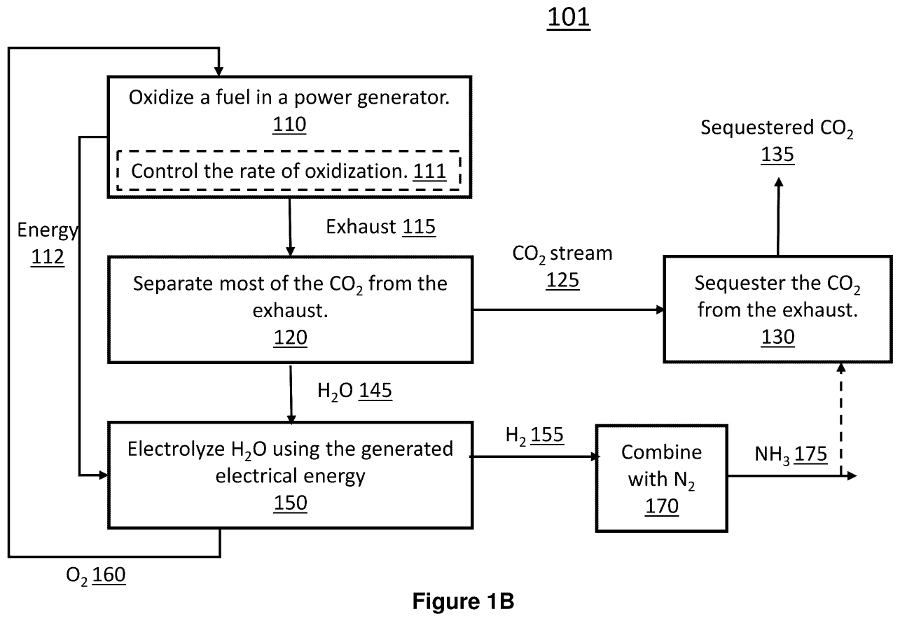

FIG. 1A provides a method 100 for synthesizing H₂ with a very low CO₂ footprint according to certain embodiments of the subject methods. Step 110 includes oxidizing a fuel that contains carbon and hydrogen in a power generator. In some embodiments, oxidizing including combusting the fuel, but other methods of oxidation may also be used. Other oxidization components include gaseous O₂. The result of the oxidization step 110 is exhaust 115 and electrical energy 112. Exhaust 115 is subsequently provided to step 120, which involves separating most of the CO₂ from the exhaust 115 to generate a CO₂-stream 125 and CO₂-depleted H₂O stream 145. The CO₂-stream 125 is input to a sequestration step 130 which generates sequestered CO₂ 135. The CO₂ depleted H₂O stream 145 and electrical energy 112 from step 110 are input to an electrolyzing step 150. H₂O from the CO₂-depleted H₂O stream 145 is electrolyzed using the generated electrical energy 112. In some embodiments, as discussed above, pure H₂O is also input to the electrolyzing step 150 to supplement the H₂O from the CO₂-depleted H₂O stream 145. In some embodiments, oxidizing the fuel at 110 also generates heat, which is used to electrolyze the H₂O from the CO₂-depleted H₂O stream at step 150. The output of step 160 is synthesized H₂ 155 and synthesized O₂ 160. Synthesized O₂ 160 is returned to step 110 where it oxidizes the fuel being oxidized in the power generator. In some embodiments, because of the separation and sequestration of most of the CO₂ in the exhaust 115 of the power generation process 110, the synthesized H₂ 155 has a very low CO₂ footprint.

In certain cases, step 100 optionally includes step 111 of controlling the rate of oxidization. Accordingly, in some embodiments, the rate of oxidization is controlled by influencing the rate at which reagents in the oxidization (e.g., combustion) reaction are consumed and exhaust is produced. Methods according to certain embodiments include supplying the power generator with a CO₂ diluent. Increasing the ratio of CO₂ to O₂ being supplied to the power generator can reduce the rate at which the O₂ is consumed. In some embodiments, the CO₂ diluent is received from the exhaust 115. In other words, CO₂ 125 produced by the power generator is provided as an input to the same power generator to influence the rate of oxidation therein. In some embodiments, in addition or in the alternative, the rate of oxidization is controlled by limiting the amount of gaseous O₂ (which is an oxidization component) supplied to the power generator. Additional embodiments include limiting the amount of fuel (which is an oxidization component) supplied to the power generator. Some amount of the non-limiting oxidization component will pass through the power generator unchanged. In some such embodiments, methods additionally include recycling the non-limited oxidization component to the power generator following oxidization. For example, depending on which of the oxidization components is limiting, methods may include recycling gaseous O₂ (e.g., synthesized gaseous O₂ and/or O₂ obtained from the atmosphere) to the power generator following oxidization. In other cases, methods may include recycling fuel to the power generator following oxidization.

Alternative embodiments of the invention include combusting fuel without controlling the rate of oxidation, e.g., via CO₂ recirculation and/or limiting an oxidization component.

### Uses of Synthesized H₂

As discussed above, a product of the subject hydrolysis reactions is H₂ 155. The synthesized H₂ 155 may subsequently be used in any suitable application, as desired. In some instances, synthesized H₂ may be employed, e.g., as fuel source, e.g., for transportation, power production, etc. For example, the synthesized H₂ 155 may be employed in a hydrogen fuel cell, e.g., in an automobile. In additional instances, synthesized H₂ may be employed as a hydrogen feedstock for chemical synthesis. In some embodiments, methods include storing the synthesized H₂ 155, e.g., for later use. In some such embodiments, the synthesized H₂ 155 is stored as a gas. For example, gaseous H₂ 155 may be stored under pressure (e.g., 5,000-10,000 psi) in a gas tank. In some cases, methods include storing H₂ 155 as a liquid (e.g., under cryogenic temperatures such as −253° C.).

Methods of interest include employing the synthesized H₂ to generate ammonia. FIG. 1B provides a method 101 for synthesizing ammonia (NH₃) with a very low CO₂ footprint according to certain embodiments of the subject methods. Method 101 is similar to method 100, except that at step 170, the synthesized H₂ 155 is used to generate ammonia (NH₃) 175. Accordingly, step 170 includes reacting the synthesized H₂ 155 with gaseous N₂ in a manner sufficient to synthesize NH₃ 175. In certain cases, the gaseous N₂ employed in NH₃ 175 production is received from the atmosphere, e.g., by an ASU. In other cases, the gaseous N₂ is provided from an alternative source (e.g., N₂ gas canisters). For example, embodiments of the subject methods include producing NH₃ 175 via the Haber-Bosch process. This process and other processes like it (e.g., Kellogg Advanced Ammonia Process (KAAP)) react N₂ with H₂ in the presence of a metal catalyst under high temperature (e.g., 400-600° C.) and pressure (e.g., 20-100 MPa). This process proceeds according to reaction (VII):

N₂+3H₂→2NH₃ (VII)

Metal catalysts of interest for the synthesis of NH₃ include, for example, iron-based catalysts and ruthenium-based catalysts. Protocols for the production of NH₃ using H₂ and N₂ may be adapted from, for example, U.S. Pat. Nos. 4,166,834; 9,150,423; 9,272,920; and 10,287,173; the disclosures of which are incorporated by reference herein in their entirety.

Ammonia 175 may be employed in any suitable application. In some embodiments, methods include optionally employing the synthesized NH₃ 175 in a carbon sequestration process (e.g., as an aqueous capture ammonia), as described above, and as illustrated in FIG. 1A. In other cases, methods include employing the synthesized NH₃ 175 in the production of one or more of the following: fertilizers, pharmaceutical products, cleaning products, ionizing solvents, nitrogenous compounds, antimicrobial agents, etc.

FIG. 2A depicts a system 200 for synthesizing H₂ with a very low CO₂ footprint that may be employed in certain embodiments of the subject methods. As shown in FIG. 2A, fuel 201 is oxidized, e.g., combusted, in power generator 202 to generate electrical energy 215. Fuel 201 contains Carbon and Hydrogen, and includes such fuels as natural gas, methane, etc. Power generator 202 includes (as shown) or is coupled to (not shown) an exhaust separator 202a that separates most of CO₂ in the exhaust of the power generator 202 to generate a CO₂-depleted H₂O stream 220 and a CO₂ stream 230. In some embodiments, at least 50% of CO₂ and at least 50% of the H₂O in the exhaust are separated out into the CO₂ stream 230 and H₂O stream 220 respectively.

In some embodiments, the CO₂ stream 230 is input to a sequestration module 203 (as described further in this specification) that sequesters the CO₂ 230. In some embodiments, a majority of the CO₂ in the stream 230, and in some cases even up to 90%-100% is sequestered by sequestration module 203. The CO₂-depleted H₂O stream 220 is subjected to an electrolysis process provided by electrolyzer 206, which process consumes electrical energy 215 generated by power generation process 202. Electrolyzer 206 synthesizes O₂ 250 and H₂ 240. Because of the separation and sequestration of most of the CO₂ in the exhaust of the power generation process 202, the synthesized H₂ 240 has a very low CO₂ footprint.

The synthesized O₂ 250 is returned to power generator 202 as an oxidization component for the oxidization of fuel 201.

Optional processes (denoted by dashed lines) in the embodiment of FIG. 2A include the provision of additional clean or pure water 210 to the electrolyzer 206, i.e., to supplement the water from the CO₂-depleted H₂O stream 220. In addition, power 211—optionally from a green power source—may supplement the electrical energy 215 from power generator 202 during electrolysis by the electrolyzer 206.

Further, in some embodiments, the system 200 is configured to obtain an O₂-containing gas (e.g., gas or air 209) from the surrounding atmosphere, which is then subjected to an air separation unit (ASU) 208. Output of the ASU is gaseous O₂ 270, which may then be supplied to power generator 202 to supplement the O₂ synthesized during electrolysis by the electrolyzer 206. In certain cases, the ratio of synthesized gaseous O₂ 250 to the obtained O₂ 270 for oxidizing the fuel 201 ranges from 90:10 to 40:60.

In addition, ASU 208 may additionally optionally involve direct air capture (DAC) device 204, configured to capture gaseous CO₂ 280 from the atmosphere 209. An optional embodiment additionally includes recycling CO₂ 230 and/or 280 to control or limit the rate of oxidization of fuel 201 in the power generator 202. Accordingly, embodiments of the system 200 additionally include a gaseous connection (not shown in FIG. 2A) for supplying the obtained gaseous CO₂ 280 to the power generator 202.

An optional embodiment additionally includes sequestering CO₂ 280, using e.g., sequestration module 203. Any convenient protocol for CO₂ sequestration may be employed, including those described above. In certain cases, sequestering the CO₂ 280 in the O₂-containing gas 209 includes combining the CO₂ 280 obtained from the atmosphere with the CO₂ 230 obtained from the exhaust such that the CO₂ from both sources is sequestered together and/or simultaneously and/or using the same sequestration module 203. For example, in certain cases, method 200 includes providing CO₂ 280 obtained from the atmosphere to the sequestration process 203, e.g., via a gaseous connection (not shown in FIG. 2A) that runs from a DAC apparatus 204 directly to the sequestration process 203.

System 200 may optionally include an oxidization rate controller 250 for controlling the rate of oxidization. In some embodiments, the oxidization rate controller 250 controls the rate of oxidization by influencing the rate at which reagents in the oxidization (e.g., combustion) reaction are consumed and exhaust is produced. Accordingly, in some embodiments, the oxidization rate controller 250 supplies the power generator 202 with a CO₂ diluent. Increasing the ratio of CO₂ to O₂ being supplied to the power generator 202 can reduce the rate at which the O₂ is consumed. In some embodiments, the CO₂ diluent is received from the exhaust 115. In other words, CO₂ 125 produced by the power generator 202 is provided as an input to the same power generator 202 to influence the rate of oxidation therein. Alternatively or in addition, CO₂ 280 may be used as CO₂ diluent.

In some embodiments, in addition or in the alternative, the oxidization rate controller 250 controls the rate of oxidization by limiting the amount of gaseous O₂ (which is an oxidization component) supplied to the power generator 202. some embodiments, in addition or in the alternative, the oxidization rate controller 250 controls the rate of oxidization by limiting the amount of fuel (which is an oxidization component) supplied to the power generator 202. Some amount of the non-limiting oxidization component will pass through the power generator 202 unchanged. In some such embodiments, the oxidization rate controller 250 may recycle the non-limited oxidization component to the power generator 202 following oxidization. For example, depending on which of the oxidization components is limiting, gaseous O₂ (e.g., synthesized gaseous O₂ 250 and/or O₂ obtained from the atmosphere 270) may be recycled to the power generator 202 following oxidization. In other cases, methods may include recycling fuel to the power generator following oxidization.

FIG. 2B depicts a flow diagram 290 for synthesizing NH₃ with a very low CO₂ footprint. Flow diagram 290 is similar to flow diagram 200, except that in the example of FIG. 2B, the synthesized H₂ 240 is subjected to an ammonia generation process 207 to generate ammonia 260 that also has a very low CO₂ footprint. An input of N₂ 295 into the ammonia generation process 207 can optionally come from the air separation protocol 208. Appropriate balancing of H₂ 240 and N₂ 295 is required to generate NH₃ 260, which can be done using methods known to those skilled in the art. In some embodiments, optionally, the generated ammonia 260 is fed into sequestration module 203 as aqueous capture liquid, such as after pressure liquification.

### Gaseous CO₂ Sequestration Module 203

Aspects of the invention additionally include protocols that provide for a gaseous CO₂ sequestration or disposition. By “gaseous CO₂ disposition”, it is meant the conversion of the gaseous CO₂ from the exhaust into a storage-stable format that may be disposed of and/or applied (e.g., in an industrial process, a construction process), optionally in such a way that the gaseous CO₂ does not return to the surrounding atmosphere. In some embodiments, the methods include a gaseous CO₂ capture protocol that provides for a gaseous CO₂ disposition via mineralization, geologic sequestration, chemical conversion, and combinations thereof.

In some embodiments, the gaseous CO₂ disposition includes mineralization. By “mineralization” it is meant that the CO₂ becomes embodied in CO₂ sequestering solid composition. Mineralization may include any convenient protocol. In some embodiments, methods of the invention include producing a building material using the CO₂ sequestering solid composition. As discussed herein, a “building material” refers to a material that may be employed in the construction of a built structure. Building materials of interest include, for example, aggregates.

In some embodiments where gaseous CO₂ is mineralized, following production of an aqueous carbonate, such as an aqueous ammonium carbonate, e.g., as described above, the aqueous carbonate is combined with a cation source under conditions sufficient to produce a solid CO₂ sequestering carbonate. Cations of different valances can form solid carbonate compositions (e.g., in the form of carbonate minerals). In some instances, monovalent cations, such as sodium and potassium cations, may be employed. In other instances, divalent cations, such as alkaline earth metal cations, e.g., calcium and magnesium cations, may be employed. When cations are added to the aqueous carbonate, precipitation of carbonate solids, such as amorphous calcium carbonate when the divalent cations include Ca²⁺, may be produced with a stoichiometric ratio of one carbonate-species ion per cation.

Any convenient cation source may be employed in such instances. Cation sources of interest include, but are not limited to, the brine from water processing facilities such as sea water desalination plants, brackish water desalination plants, groundwater recovery facilities, wastewater facilities, and the like, which produce a concentrated stream of solution high in cation contents. Also of interest as cation sources are naturally occurring sources, such as but not limited to native seawater and geological brines, which may have varying cation concentrations and may also provide a ready source of cations to trigger the production of carbonate solids from the aqueous ammonium carbonate. In some instances, the cation source may be a waste product of another step of the process, e.g., a calcium salt (such as CaCl₂)) produced during regeneration of ammonia from the aqueous ammonium salt.

The product carbonate compositions may vary greatly. The precipitated product may include one or more different carbonate compounds, such as two or more different carbonate compounds, e.g., three or more different carbonate compounds, five or more different carbonate compounds, etc., including non-distinct, amorphous carbonate compounds. Carbonate compounds of precipitated products of the invention may be compounds having a molecular formulation Xₘ(CO₃)ₙ where X is any element or combination of elements that can chemically bond with a carbonate group or its multiple, wherein X is in certain embodiments an alkaline earth metal and not an alkali metal; wherein m and n are stoichiometric positive integers. These carbonate compounds may have a molecular formula of Xₘ(CO₃)ₙH₂O, where there are one or more structural waters in the molecular formula. The amount of carbonate in the product, as determined by coulometry using the protocol described as coulometric titration, may be 40% or higher, such as 70% or higher, including 80% or higher.

The carbonate compounds of the precipitated products may include a number of different cations, such as but not limited to ionic species of: calcium, magnesium, sodium, potassium, sulfur, boron, silicon, strontium, and combinations thereof. Of interest are carbonate compounds of divalent metal cations, such as calcium and magnesium carbonate compounds. Specific carbonate compounds of interest include, but are not limited to: calcium carbonate minerals, magnesium carbonate minerals and calcium magnesium carbonate minerals. Calcium carbonate minerals of interest include, but are not limited to: calcite (CaCO₃), aragonite (CaCO₃), vaterite (CaCO₃), ikaite (CaCO₃·6H₂O), and amorphous calcium carbonate (CaCO₃). Magnesium carbonate minerals of interest include, but are not limited to magnesite (MgCO₃), barringtonite (MgCO₃·2H₂O), nesquehonite (MgCO₃·3H₂O), lanfordite (MgCO₃·5H₂O), hydromagnisite, and amorphous magnesium calcium carbonate (MgCO₃). Calcium magnesium carbonate minerals of interest include, but are not limited to dolomite (CaMg)(CO₃)₂), huntite (Mg₃Ca(CO₃)₄) and sergeevite (Ca₂Mg₁₁(CO₃)₁₃·H₂O). The carbonate compounds of the product may include one or more waters of hydration, or may be anhydrous. In some instances, the amount by weight of magnesium carbonate compounds in the precipitate exceeds the amount by weight of calcium carbonate compounds in the precipitate. For example, the amount by weight of magnesium carbonate compounds in the precipitate may exceed the amount by weight calcium carbonate compounds in the precipitate by 5% or more, such as 10% or more, 15% or more, 20% or more, 25% or more, 30% or more. In some instances, the weight ratio of magnesium carbonate compounds to calcium carbonate compounds in the precipitate ranges from 1.5-5 to 1, such as 2-4 to 1 including 2-3 to 1. In some instances, the precipitated product may include hydroxides, such as divalent metal ion hydroxides, e.g., calcium and/or magnesium hydroxides. Further details regarding carbonate production and methods of using the carbonate produced thereby are provided in: U.S. Pat. Nos. 9,707,513; 9,714,406; 9,993,799; 10,197,747; 10,203,434 and 10,711,236 the disclosures of which are herein incorporated by reference.

In some cases, the gaseous CO₂ from the exhaust is mineralized in an aggregate (e.g., a carbonate aggregate or a carbonate-coated aggregate). The term “aggregate” is used in its conventional sense to refer to a granular material, i.e., a material made up of grains or particles. As the aggregate is a carbonate aggregate, the particles of the granular material include one or more carbonate compounds, where the carbonate compound(s) component may be combined with other substances (e.g., substrates) or make up the entire particles, as desired. Exemplary systems and methods are described in U.S. Pat. No. 7,914,685 and Published PCT Application Publication No. WO 2020/154518, the disclosures of which are herein incorporated by reference in their entirety.

In certain aspects, methods of the invention include producing carbonate coated aggregates, e.g., for use in concretes and other applications. The carbonate coated aggregates may be conventional or lightweight aggregates. The CO₂ sequestering aggregate compositions include aggregate particles having a core and a CO₂ sequestering carbonate coating on at least a portion of a surface of the core. The CO₂ sequestering carbonate coating is made up of a CO₂ sequestering carbonate material, e.g., as described above.

In some instances, the aggregate is produced by a protocol in which a carbonate slurry is introduced into a revolving drum and mixed in the revolving drum under conditions sufficient to produce a carbonate aggregate. In some instances, the carbonate slurry is introduced into the revolving drum with an aggregate substrate, e.g., a warmed aggregate such as described above, and then mixed in the revolving drum to produce a carbonate coated aggregate. In certain cases, the slurry (and substrate) are introduced into the revolving drum and mixing is commenced shortly after production of the carbonate slurry, such as within 12 hours, such as within 6 hours and including within 4 hours of preparing the carbonate slurry. In some instances, the entire process (i.e., from commencement of slurry preparation to obtainment of carbonate aggregate product) is performed in 15 hours or less, such as 10 hours or less, including 5 hours or less, e.g., 3 hours or less, including 1 hour less. Further details regarding such protocols may be found in Published PCT Application Publication No. WO 2020/154518; the disclosure of which is herein incorporated by reference.

In some instances, carbonate production occurs in a continuous fashion, e.g., as described in U.S. Pat. No. 9,993,799; the disclosure of which is herein incorporated by reference. In some such instances, carbonate production may occur in the presence of a seed structure. By seed structure is meant a solid structure or material that is present flowing liquid, e.g., in the material production zone, prior to divalent cation introduction into the liquid. By “in association with” is meant that the material is produced on at least one of a surface of or in a depression, e.g., a pore, crevice, etc., of the seed structure. In such instances, a composite structure of the carbonate material and the seed structure is produced. In some instances, the product carbonate material coats a portion, if not all of, the surface of a seed structure. In some instances, the product carbonate materials fills in a depression of the seed structure, e.g., a pore, crevice, fissure, etc.

Seed structures may vary widely as desired. The term “seed structure” is used to describe any object upon and/or in which the product carbonate material forms. Seed structures may range from singular objects or particulate compositions, as desired. Where the seed structure is a singular object, it may have a variety of different shapes, which may be regular or irregular, and a variety of different dimensions. Shapes of interest include, but are not limited to, rods, meshes, blocks, etc. Also of interest are particulate compositions, e.g., granular compositions, made up of a plurality of particles. Where the seed structure is a particulate composition, the dimensions of particles may vary, ranging in some instances from 0.01 to 1,000,000 μm, such as 0.1 to 100,000 μm.

The seed structure may be made up of any convenient material or materials. Materials of interest include both carbonate materials, such as described above, as well as non-carbonate materials. The seed structures may be naturally occurring, e.g., naturally occurring sands, shell fragments from oyster shells or other carbonate skeletal allochems, gravels, etc., or man-made, such as pulverized rocks, ground blast furnace slag, fly ash, cement kiln dust, red mud, returned concrete, recycled concrete, demolished concrete and the like. For example, the seed structure may be a granular composition, such as sand, which is coated with the carbonate material during the process, e.g., a white carbonate material or colored carbonate material, e.g., as described above.

In some instances, seed structure may be coarse aggregates, such as friable Pleistocene coral rock, e.g., as may be obtained from tropical areas (e.g., Florida) that are too weak to serve as aggregate for concrete. In this case the friable coral rock can be used as a seed, and the solid CO₂ sequestering carbonate mineral may be deposited in the internal pores, making the coarse aggregate suitable for use in concrete, allowing it to pass the LA Rattler abrasion test. In some instances, where a lightweight aggregate is desired, the outer surface will only be penetrated by the solution of deposition, leaving the inner core relatively ‘hollow’ making a lightweight aggregate for use in light weight concrete.

In embodiments, settable compositions of the invention, such as concretes and mortars, are produced by combining a hydraulic cement with an amount of aggregate (fine for mortar, e.g., sand; coarse with or without fine for concrete) and water, either at the same time or by pre-combining the cement with aggregate, and then combining the resultant dry components with water. The choice of coarse aggregate material for concrete mixes using cement compositions of the invention may have a minimum size of about ⅜ inch and can vary in size from that minimum up to one inch or larger, including in gradations between these limits. Finely divided aggregate is smaller than ⅜ inch in size and again may be graduated in much finer sizes down to 200-sieve size or so. Fine aggregates may be present in both mortars and concretes of the invention. The weight ratio of cement to aggregate in the dry components of the cement may vary, and in certain embodiments ranges from 1:10 to 4:10, such as 2:10 to 5:10 and including from 55:1000 to 70:100.

By “settable cementitious composition” is meant a flowable composition that is prepared from a cement and a setting liquid, where the flowable composition sets into a solid product following preparation. Settable cementitious compositions of the invention may be prepared from combination of a cement, a setting liquid and a BRP additive/admixture, where the compositions may further include one or more additional components, such as but not limited to: aggregates, chemical admixtures, mineral admixtures, etc. Exemplary methods and systems for producing CO₂ embodied cement are described in U.S. Pat. Nos. 9,714,406 and 10,711,236, the disclosures of which are incorporated by reference in their entirety.

The liquid phase, e.g., aqueous fluid, with which the dry component is combined to produce the settable composition, e.g., concrete, may vary, from pure water to water that includes one or more solutes, additives, co-solvents, etc., as desired. The ratio of dry component to liquid phase that is combined in preparing the settable composition may vary, and in certain embodiments ranges from 2:10 to 7:10, such as 3:10 to 6:10 and including 4:10 to 6:10.

In some instances, the product bicarbonate rich product compositions are employed as bicarbonate additives for cements. The term “bicarbonate additive” as used herein means any composition, which may be liquid or solid, that includes bicarbonate (HCO₃⁻) ions, or a solid derivative thereof. The bicarbonate additive employed to produce a given settable cementitious composition may be a liquid or solid. When present as a solid, the solid is a dehydrated version of a liquid bicarbonate additive. The solid may be one that is produced from a liquid bicarbonate additive using any convenient protocol for removed water from the liquid, e.g., evaporation, freeze drying, etc. Upon combination with a suitable volume of water, the resultant solid dissolves in the water to produce a liquid bicarbonate additive, e.g., as described above. In some instances, reconstitution is achieved by combining the dry bicarbonate additive with a sufficient amount of liquid, e.g., aqueous medium, such as water, where the liquids to solids ratio employed may vary, and in some instances ranges from 1,000,000 to 1, such as 100,000 to 10. Solid bicarbonate additives may include a variety of different particle sizes and particle size distributions. For example, in some embodiments a solid bicarbonate additive may include particulates having a size ranging from 1 to 10,000 μm, such as 10 to 1,000 μm and including 50 to 500 μm.

Aspects of the invention further include settable cementitious compositions prepared from the bicarbonate rich product additives and admixtures. Admixtures of interest include, but are not limited to: set accelerators, set retarders, air-entraining agents, de-foamers, alkali-reactivity reducers, bonding admixtures, dispersants, coloring admixtures, corrosion inhibitors, damp-proofing admixtures, gas formers, permeability reducers, pumping aids, shrinkage compensation admixtures, fungicidal admixtures, germicidal admixtures, insecticidal admixtures, rheology modifying agents, wetting agents, strength enhancing agents, water repellents, etc.

The term “cement” as used herein refers to a particulate composition that sets and hardens after being combined with a setting fluid, e.g., an aqueous solution, such as water. The particulate composition that makes up a given cement may include particles of various sizes. In some instances, a given cement may be made up of particles having a longest cross-sectional length (e.g., diameter in a spherical particle) that ranges from 1 nm to 100 μm, such as 10 nm to 20 μm and including 15 nm to 10 μm.

Cements of interest include hydraulic cements. The term “hydraulic cement” as used herein refers to a cement that, when mixed with a setting fluid, hardens due to one or more chemical reactions that are independent of the water content of the mixture and are stable in aqueous environments. As such, hydraulic cements can harden underwater or when constantly exposed to wet weather conditions. Hydraulic cements of interest include, but are not limited to Portland cements, modified Portland cements, and blended hydraulic cements.

The components of the settable composition can be combined using any convenient protocol. Each material may be mixed at the time of work, or part of or all of the materials may be mixed in advance. Alternatively, some of the materials are mixed with water with or without admixtures, such as high-range water-reducing admixtures, and then the remaining materials may be mixed therewith. As a mixing apparatus, any conventional apparatus can be used. For example, Hobart mixer, slant cylinder mixer, Omni Mixer, Henschel mixer, V-type mixer, and Nauta mixer can be employed.

Also of interest is the production of formed building materials. The formed building materials of the invention may vary greatly. By “formed” is meant shaped, e.g., molded, cast, cut or otherwise produced, into a man-made structure defined physical shape, i.e., configuration. Formed building materials are distinct from amorphous building materials, e.g., particulate (such as powder) compositions that do not have a defined and stable shape, but instead conform to the container in which they are held, e.g., a bag or other container. Illustrative formed building materials include, but are not limited to: bricks; boards; conduits; beams; basins; columns; drywalls etc. Further examples and details regarding formed building materials include those described in United States Published Application No. US20110290156; the disclosure of which is herein incorporated by reference.

Also of interest are non-cementitious manufactured items that include the product of the invention as a component. Non-cementitious manufactured items of the invention may vary greatly. By non-cementitious is meant that the compositions are not hydraulic cements. As such, the compositions are not dried compositions that, when combined with a setting fluid, such as water, set to produce a stable product. Illustrative compositions include, but are not limited to: paper products; polymeric products; lubricants; asphalt products; paints; personal care products, such as cosmetics, toothpastes, deodorants, soaps and shampoos; human ingestible products, including both liquids and solids; agricultural products, such as soil amendment products and animal feeds; etc. Further examples and details non-cementitious manufactured items include those described in U.S. Pat. No. 7,829,053; the disclosure of which is herein incorporated by reference.

Further details regarding carbonate production and methods of using the carbonated produced thereby are provided in U.S. Pat. Nos. 9,714,406; 10,711,236; 10,203,434; 9,707,513; 10,287,439; 9,993,799; 10,197,747; and 10,322,371; as well as published PCT Application Publication Nos. WO 2020/047243 and WO 2020/154518; the disclosures of which are herein incorporated by reference.

In embodiments involving the production of solid carbonate compositions from the bicarbonate rich product or component thereof (e.g., LCP), one mol of CO₂ may be produced for every 2 mols of bicarbonate ion from the bicarbonate rich product or component thereof (e.g., LCP). Contact of the bicarbonate rich product with the cation source results in production of a substantially pure CO₂ product gas. The phrase “substantially pure” means that the product gas is pure CO₂ or is a CO₂ containing gas that has a limited amount of other, non-CO₂ components.

Following production of the CO₂ product gas, aspects of the invention may include injecting the product CO₂ gas into a subsurface geological location to sequester CO₂ (i.e., geological sequestration). By injecting is meant introducing or placing the CO₂ product gas into a subsurface geological location. Subsurface geological locations may vary, and include both subterranean locations and deep ocean locations. Subterranean locations of interest include a variety of different underground geological formations, such as fossil fuel reservoirs, e.g., oil fields, gas fields and un-mineable coal seams; saline reservoirs, such as saline formations and saline-filled basalt formations; deep aquifers; porous geological formations such as partially or fully depleted oil or gas formations, salt caverns, sulfur caverns and sulfur domes; etc.

In some instances, the CO₂ product gas may be pressurized prior to injection into the subsurface geological location. To accomplish such pressurization the gaseous CO₂ can be compressed in one or more stages with, where desired, after cooling and condensation of additional water. The modestly pressurized CO₂ can then be further dried, where desired, by conventional methods such as through the use of molecular sieves and passed to a CO₂ condenser where the CO₂ is cooled and liquefied. The CO₂ can then be efficiently pumped with minimum power to a pressure necessary to deliver the CO₂ to a depth within the geological formation or the ocean depth at which CO₂ injection is desired. Alternatively, the CO₂ can be compressed through a series of stages and discharged as a super critical fluid at a pressure matching that necessary for injection into the geological formation or deep ocean. Where desired, the CO₂ may be transported, e.g., via pipeline, rail, truck, sea or other suitable protocol, from the production site to the subsurface geological formation.

In some instances, the CO₂ product gas is employed in an enhanced oil recovery (EOR) protocol. Enhanced Oil Recovery (abbreviated EOR) is a generic term for techniques for increasing the amount of crude oil that can be extracted from an oil field. Enhanced oil recovery is also called improved oil recovery or tertiary recovery. In EOR protocols, the CO₂ product gas is injected into a subterranean oil deposit or reservoir. CO₂ gas production and sequestration thereof is further described in U.S. application Ser. No. 14/861,996, the disclosure of which is herein incorporated by reference.

In some instances, CO₂ sequestered by the present invention may be employed in albedo enhancing applications. Albedo, i.e., reflection coefficient, refers to the diffuse reflectivity or reflecting power of a surface. It is defined as the ratio of reflected radiation from the surface to incident radiation upon it. Albedo is a dimensionless fraction, and may be expressed as a ratio or a percentage. Albedo is measured on a scale from zero for no reflecting power of a perfectly black surface, to 1 for perfect reflection of a white surface. While albedo depends on the frequency of the radiation, as used herein Albedo is given without reference to a particular wavelength and thus refers to an average across the spectrum of visible light, i.e., from about 380 to about 740 nm. Exemplary systems and methods for enhancing albedo can be found in U.S. Pat. No. 10,203,434; and U.S. Patent Application Publication No. 2019/0179061; the disclosures of which are herein incorporated by reference.

Aspects of the invention include associating with a surface of interest an amount of a highly reflective microcrystalline or amorphous material composition effective to enhance the albedo of the surface by a desired amount. The material composition may be associated with the target surface using any convenient protocol. As such, the material composition may be associated with the target surface by incorporating the material into the material of the object having the surface to be modified. For example, where the target surface is the surface of a building material, such as a roof tile or concrete mixture, the material composition may be included in the composition of the material so as to be present on the target surface of the object. Alternatively, the material composition may be positioned on at least a portion of the target surface, e.g., by coating the target surface with the composition. Where the surface is coated with the material composition, the thickness of the resultant coating on the surface may vary, and in some instances may range from 0.1 mm to 25 mm, such as 2 mm to 20 mm and including 5 mm to 10 mm. Applications in use as highly reflective pigments in paints and other coatings like photovoltaic solar panels are also of interest.

### Systems for Synthesizing NH₃

As discussed above, aspects of the invention include systems for synthesizing NH₃. Systems of interest include a power generator configured to oxidize a fuel to generate electrical energy and an exhaust comprising CO₂ and H₂O, a CO₂ sequestration unit gaseously connected to the power generator and configured to produce a CO₂-depleted H₂O stream, and an electrolyzer configured to electrolyze H₂O from the CO₂-depleted H₂O stream using the electrical energy from the power generator and synthesize gaseous O₂ and H₂. Systems of the invention also include a reactor configured to synthesize NH₃ from N₂ and the synthesized H₂.

### Power Generator 202

Power generators employed in the subject systems may vary. The power generator may be configured to produce any convenient amount of electrical energy. In certain embodiments, the power generator is configured to produce 2 MW or more, such as 5 MW or more, such as 10 MW or more, such as 100 MW or more, such as 500 MW or more, such as 1000 MW or more, such as 2 gW or more, and including 10 gW or more. In various instances, power generators include an intake for receiving fuel into the power generator. In some aspects, power generators include at least one conversion element for converting the materials and/or energy received into the intake to electric power. In some instances, power generators include an electrical yield component configured for providing an output of electrical power from the power generator. In various embodiments, power generators include one or more control systems configured for controlling the amount of fuel into an intake and/or for controlling the amount of fuel converted to electric power and/or for controlling the amount of electric power output through the electrical yield component.

In certain instances, power generators include a gas turbine. Any suitable gas turbine may be employed, including, but not limited to simple cycle gas turbines, and combined cycle gas turbines. Various gas turbines are described in, e.g., the exemplary disclosures provided in the Methods section.

In additional instances, power generators of interest include a gas boiler. Any suitable gas boiler may be employed. In some cases, the gas boiler is a supercritical steam generator operating at supercritical pressure (i.e., above the critical point of a phase equilibrium curve). As such, in some cases, the subject gas boilers operate at pressures that are greater than 3,200 psi or 22 MPa. In some embodiments, gas boilers employed herein involve the use of superheated steam (i.e., steam at a temperature that is higher than its vaporization point). Various gas boilers are described in, e.g., the exemplary disclosures provided in the Methods section.

In certain embodiments the power generator comprises a heat recovery steam generator (HRSG). In some embodiments, HRSGs may be employed in a cogeneration process that simultaneously generates electricity and heat energy. In additional embodiments, HRSGs are employed in a combined cycle power generation system where heat engines produce energy from the same heat source. HRSGs of interest include, for example, an economizer, evaporator, superheater and water preheater. Various HRSGs and components thereof are described in, e.g., the exemplary disclosures provided in the Methods section.

### CO₂ Sequestration Units

Systems of interest additionally include a CO₂ sequestration unit gaseously connected to the power generator. By “gaseously connected”, it is meant that the CO₂ sequestration unit and power generator include a conduit (e.g., pipe, tubing, etc.) positioned therebetween configured to convey the exhaust from the power generator to the CO₂ sequestration unit in a gaseous and/or liquid form. CO₂ sequestration units of the invention may have any configuration that enables practice of the particular sequestration method of interest. In embodiments, CO₂ sequestration units of the invention include one or more reactors that are configured for producing CO₂ sequestering carbonate materials. In some embodiments, the CO₂ sequestration units include continuous reactors (i.e., flow reactors), e.g., reactors in which materials are carried in a flowing stream, where reactants (e.g., divalent cations, aqueous bicarbonate rich liquid, aqueous capture ammonia etc.) are continuously fed into the reactor and emerge as continuous stream of product. A given system may include the continuous reactors, e.g., as described herein, in combination with one or more additional elements, as described in greater detail below. In other embodiments, the subject systems include batch reactors.

The power generator may be connected to an absorber in the sequestration unit configured to contact the exhaust with the capture liquid. The absorber may include any of a number of components, such as temperature regulators (e.g., configured to heat the liquid to a desired temperature or cool the gas to a desired temperature), chemical additive components, e.g., for introducing agents that enhance bicarbonate production, mechanical agitation and physical stirring mechanisms. The absorber may include a catalyst that mediates the conversion of CO₂ to bicarbonate. The absorber may also include components that allow for the monitoring of one or more parameters such as internal reactor pressure, pH, metal-ion concentration, and partial pressure of CO₂. In some cases, the capture liquid has a pH of about 10 or more. Examples of such protocols include, but are not limited to, those described in U.S. Pat. Nos. 8,333,944; 8,177,909; 8,137,455; 8,114,214; 8,062,418; 8,006,446; 7,939,336; 7,931,809; 7,922,809; 7,914,685; 7,906,028; 7,887,694; 7,829,053; 7,815,880; 7,771,684; 7,753,618; 7,749,476; 7,744,761; and 7,735,274; the disclosures of which are herein incorporated by reference.

In embodiments, systems further include a divalent cation introducer configured to introduce divalent cations at an introduction location into the flowing aqueous liquid. Any convenient introducer may be employed, where the introducer may be a liquid phase or solid phase introducer, depending on the nature of the divalent cation source. The introducer may be positioned at any convenient location. The introducer may be located in some instances at substantially the same, if not the same, position as the inlet for the bicarbonate rich product containing liquid. Alternatively, the introducer may be located at a distance downstream from the inlet. In such instances, the distance between the inlet and the introducer may vary, ranging in some embodiments from 1 cm to 100 km, such as 10 cm to 1 m. The introducer may be operatively coupled to a source or reservoir of divalent cations. In some cases, the divalent cation introducer is located at the outlet of the absorber (e.g., where liquid exits the absorber and enters, for example, a reactor).

In some instances, the systems include a reactor, such as an agglomeration module, configured to further process the bicarbonate rich product, e.g., to dry the product, to combine the product with one or more additional components, e.g., a cement additive, to produce solid carbonate compositions from a bicarbonate rich product, etc. For embodiments where the reactor is configured to produce a carbonate product, such reactors include an input for the bicarbonate rich product, as well as an input for a source of cations (such as described above) which introduces the cations into the bicarbonate rich product in a manner sufficient to cause precipitation of solid carbonate compounds. Where desired, this reactor may be operably coupled to a separator configured to separate a precipitated carbonate mineral composition from a mother liquor, which are produced from the bicarbonate rich product in the reactor. In certain embodiments, the separator may achieve separation of a precipitated carbonate mineral composition from a mother liquor by a mechanical approach, e.g., where bulk excess water is drained from the precipitate by gravity or with the addition of a vacuum, mechanical pressing, filtering the precipitate from the mother liquor to produce a filtrate, centrifugation or by gravitational sedimentation of the precipitate and drainage of the mother liquor. The system may also include a washing station where bulk dewatered precipitate from the separator is washed, e.g., to remove salts and other solutes from the precipitate, prior to drying at the drying station. In some instances, the system further includes a drying station for drying the precipitated carbonate mineral composition produced by the carbonate mineral precipitation station. Depending on the particular drying protocol of the system, the drying station may include a filtration element, freeze drying structure, spray drying structure, etc. as described more fully above. The system may include a conveyer, e.g., duct, from the industrial plant that is connected to the dryer so that a gaseous waste stream (i.e., industrial plant flue gas) may be contacted directly with the wet precipitate in the drying stage. The resultant dried precipitate may undergo further processing, e.g., grinding, milling, in refining station, in order to obtain desired physical properties. One or more components may be added to the precipitate where the precipitate is used as a building material.

Continuous reactors of interest also include a non-slurry solid phase CO₂ sequestering carbonate material production location. This location is a region or area of the continuous reactor where a non-slurry solid phase CO₂ sequestering carbonate material is produced as a result of reaction of the divalent cations with bicarbonate ions of the bicarbonate rich product containing liquid. The reactor may be configured to produce any of the non-slurry solid phase CO₂ sequestering carbonate materials described above in the production location. In some instances, the production location is located at a distance from the divalent cation introduction location. While this distance may vary, in some instances the distance between the divalent cation introducer and the material production location ranges from 1 cm to 100 km.

Where desired, the reactor may further include a retaining structure configured to retain non-slurry solid phase CO₂ sequestering carbonate materials in the material production location. Retaining structures of interest include filters, meshes or analogous structures (e.g., frits) which serve to maintain the non-slurry solid phase CO₂ sequestering carbonate materials in the production location despite the movement of the aqueous bicarbonate rich product containing liquid through the production location.

The reactor may have a flow modulator that is configured to maintain a desired flow rate of liquid through the reactor or portion thereof. For example, the flow modulator may be configured to maintain a constant and desired rate of liquid flow through the reactor, or may be configured to vary the flow rate of the liquid through different portions of the reactor, such that the reactor may have a first flow rate in a first portion and a second flow rate in a second portion. The flow modulator may be configured to provide for liquid flow through the reactor at values ranging from 0.1 m/s to 10 m/s, such as 1 m/s to 5 m/s.

The reactor may have a pressure modulator that is configured to maintain a desired pressure in the reactor or portion thereof. For example, the pressure modulator may be configured to maintain a constant and desired pressure throughout the reactor, or may be configured to vary the pressure in different portions of the reactor, such that the reactor may have a first pressure in a first portion and a second pressure in a second portion. For example, the reactor may have a higher pressure in the region of divalent cation introduction and a lower pressure in the region of material production. In such instances, the difference in pressure between any two regions may vary, ranging in some instances from 0.1 atm to 1,000 atm, such as 1 atm to 10 atm. The pressure modulator may be configured to provide for pressure in the reactor at a value ranging from 0.1 atm to 1,000 atm, such as 1 atm to 10 atm, which may vary among different regions of the reactor, e.g., as described above.

The reactor may have a temperature modulator that is configured to maintain a desired temperature in the reactor or portion thereof. For example, the temperature modulator may be configured to maintain a constant and desired temperature throughout the reactor, or may be configured to vary the temperature in different portions of the reactor, such that the reactor may have a first temperature in a first portion and a second temperature in a second portion of the reactor. The temperature modulator may be configured to provide for temperature in the reactor having a value ranging from −4 to 99° C., such as 0 to 80° C. The reactor may include an agitator, e.g., to stir or agitate the non-slurry product during production. Any convenient type of agitator may be employed, including, but not limited to, a trommel, a vibration source, etc.

Any convenient bicarbonate buffered aqueous medium source may be included in the system. In certain embodiments, the source includes a structure having an input for aqueous medium, such as a pipe or conduit from an ocean, etc. Where the aqueous medium is seawater, the source may be an input that is in fluid communication with the sea water, e.g., such as where the input is a pipeline or feed from ocean water to a land based system or an inlet port in the hull of ship, e.g., where the system is part of a ship, e.g., in an ocean based system.

The reactor further includes an output conveyance for the bicarbonate rich product. In some embodiments, the output conveyance may be configured to transport the bicarbonate rich component to a storage site, such as an injection into subsurface brine reservoirs, a tailings pond for disposal or in a naturally occurring body of water, e.g., ocean, sea, lake, or river. In yet other embodiments, the output may transfer the bicarbonate rich product to a packaging station, e.g., for putting into containers and packaging with a hydraulic cement. Alternatively, the output may convey the bicarbonate rich product to second reactor, which may be configured to produce solid carbonate compositions, i.e., precipitates, from the bicarbonate rich product.

The exhaust, e.g., as described above, may be contacted with the aqueous capture liquid, e.g., aqueous capture ammonia, using any convenient protocol. For example, contact protocols of interest include, but are not limited to: direct contacting protocols, e.g., bubbling the gas through a volume of the aqueous medium, concurrent contacting protocols, i.e., contact between unidirectionally flowing gaseous and liquid phase streams, countercurrent protocols, i.e., contact between oppositely flowing gaseous and liquid phase streams, and the like. Contact may be accomplished through use of infusers, bubblers, fluidic Venturi reactors, spargers, gas filters, sprays, trays, scrubbers, absorbers or packed column reactors, and the like, as may be convenient. In some instances, the contacting protocol may use a conventional absorber or an absorber froth column, such as those described in U.S. Pat. Nos. 7,854,791; 6,872,240; and 6,616,733; and in United States Patent Application Publication US-2012-0237420-A1; the disclosures of which are herein incorporated by reference. The process may be a batch or continuous process. In some instances, a regenerative froth contactor (RFC) may be employed to contact the CO₂ containing gas with the aqueous capture liquid, e.g., aqueous capture ammonia. In some such instances, the RFC may use a catalyst (such as described elsewhere), e.g., a catalyst that is immobilized on/to the internals of the RFC. Further details regarding a suitable RFC are found in U.S. Pat. No. 9,545,598, the disclosure of which is herein incorporated by reference.

In certain cases where the capture liquid includes ammonia, CO₂ sequestration units may be additionally configured to combine the produced aqueous ammonium carbonate with a cation source under conditions sufficient to produce a solid CO₂ sequestering carbonate and an aqueous ammonium salt. Cations of different valances can form solid carbonate compositions (e.g., in the form of carbonate minerals). In some instances, monovalent cations, such as sodium and potassium cations, may be employed. In other instances, divalent cations, such as alkaline earth metal cations, e.g., calcium and magnesium cations, may be employed. When cations are added to the aqueous ammonium carbonate, precipitation of carbonate solids, such as amorphous calcium carbonate when the divalent cations include Ca²⁺, may be produced with a stoichiometric ratio of one carbonate-species ion per cation.

In some instances where the capture liquid includes ammonia, systems of interest further include a reformer configured to regenerate aqueous capture ammonia from the aqueous ammonium salt. The reformer may regenerate aqueous capture ammonia via any convenient mechanism. In some instances, a distillation protocol is employed. While any convenient distillation protocol may be employed, in some embodiments the employed distillation protocol includes heating the aqueous ammonium salt in the presence of an alkalinity source to produce a gaseous ammonia/water product, which may then be condensed to produce a liquid aqueous capture ammonia. The alkalinity source may vary, so long as it is sufficient to convert ammonium in the aqueous ammonium salt to ammonia. Any convenient alkalinity source may be employed. Exemplary alkalinity sources are described in the Methods section.

In some embodiments, CO₂ sequestration units include chemical scrubbers such as amine scrubbers. Amine scrubbing is referred to herein in its conventional sense to describe the process of absorbing gaseous CO₂ into a liquid (e.g., aqueous solution) that comprises alkylamines (often referred to as “amines”). Amine scrubbers are described in, for example, G. T. Rochelle, Science 325, 1652 (2009), herein incorporated by reference in its entirety. The process of amine scrubbing involves the removal of acid gases (often referred to as “sour gas”) such as CO₂—and, where relevant, hydrogen sulfide (H₂S)—by contacting such gases with an amine solution to form salt complexes. Amine solutions may include, but are not limited to, monoethanolamine, diethanolamine, methyldiethanolamine, diglycolamine, or the like, and combinations thereof. Amine scrubbers of interest include a contactor column (e.g., a tray column, a packed column) in which gaseous CO₂ and amine solution are brought into contact. In embodiments, the contactor column includes an inlet at a bottom portion for receiving gaseous CO₂. This sour gas subsequently travels upward through the column. In some versions, the contactor column additionally includes an inlet at a top portion for receiving the lean amine solution, which solution subsequently travels downward through the column and thereby contacts the gaseous CO₂. Contactor columns may further include discharge for releasing a sweet gas (i.e., gas from which gaseous CO₂ has been removed) at a top portion of the column. In certain cases, the sweet gas discharge releases the sweet gas into the environment. Contactor columns may additionally include a discharge for releasing rich amine (i.e., CO₂- and, in some cases, H₂S-rich) solution from the column.

In embodiments, the amine scrubbers additionally include a regenerator column (often referred to as a “stripper column”). Regenerator columns of interest receive rich amine from the discharge of the contactor column and separate CO₂—and, where desired, H₂S—from the rich amine to regenerate the lean amine solution for subsequent use in the contactor column. In certain cases, the regenerator column includes a rich amine inlet located at the top of the column. Rich amine inserted at the top of the column subsequently flows down the column and is heated (e.g., by steam). The heat is configured to separate the acid gasses from the amine solution. The acid gasses travel upwards to an acid gas discharge where they may be collected for subsequent use (e.g., in an industrial process) or disposed of, as desired. The subject regenerator may have any convenient configuration and may, in certain instances, include a matrix configuration, internal exchange configuration, flashing feed configuration or a multi-pressure with split feed configuration.

In certain cases, the gaseous CO₂ sequestration unit employs a gaseous CO₂ capture protocol involving membrane transport. By “membrane transport” it is meant that at least one portion of the gaseous CO₂ capture protocol includes the separation of two or more components via transport across a membrane. Exemplary CO₂ capture protocols involving membrane transport are described in U.S. Pat. No. 7,132,090; the disclosure of which is herein incorporated by reference in its entirety. In certain versions, the gaseous CO₂ capture system includes a microporous gas diffusion membrane configured to facilitate the transport of gaseous CO₂ therethrough. In some instances, gaseous CO₂ (e.g., from one or more of the sources described above) is diffused through the membrane into an aqueous medium (e.g., such as those described above). In some instances, the aqueous medium is a capture liquid (e.g., such as those described above). In such instances, the capture liquid may subject to any of the applicable processes described herein with respect to such capture liquids. Suitable membranes include, but are not limited to a polypropylene gas exchange membrane, ePTFE (GORE-TEX), Zeolites, chytosan, polyvinylpyrollindine, cellulose acetate, immobilized liquid membranes, or the like.

In some cases, CO₂-rich fluid emerging from the gas diffusion membrane is passed by a matrix that contains a catalyst specific for CO₂. For example, in some cases, the catalyst is carbonic anhydrase and the passage of the fluid past the carbonic anhydrase produces carbonic acid. Once carbonic acid is formed, it spontaneously dissociates and forms a pH dependent equilibrium between carbonate ions and bicarbonate. In certain embodiments, gaseous CO₂ capture systems include a base source (i.e., a substance that, when added to a solution, raises the pH of said solution). Base from the base source may, in certain cases, be applied to shift the equilibrium in favor of carbonate ions thereby accelerating the rate at which CO₂ enters the fluid.

### Electrolyzers

As discussed above, systems also include an electrolyzer configured to electrolyze H₂O from the CO₂-depleted H₂O stream using the electrical energy from the power generator. Any suitable electrolyzer configured to synthesize gaseous O₂ and H₂ from H₂O may be employed. Electrolyzers suitable for use in the subject methods vary and generally differ in the type of electrolyte and the ionic species conducted. In some cases, the electrolyzer is an alkaline water electrolysis (AWE) electrolyzer. In AWE electrolyzers, the electrodes operate in a liquid alkaline electrolyte solution of potassium hydroxide (KOH) or sodium hydroxide (NaOH). In certain cases, AWE electrolyzers include a diaphragm or membrane separating the produced O₂ and H₂ that is configured to transport hydroxide ions (OH⁻) from one electrode to the other. Alkaline water electrolyzers are described in, e.g., the exemplary disclosures provided in the Methods section.

In certain cases, the electrolyzer is a proton exchange membrane (PEM) electrolyzer. A PEM is a semipermeable membrane that is permeable to protons. The PEM additionally acts as an electronic insulator and a barrier between the produced hydrogen and oxygen. In certain cases, PEMs are produced from ionomers. In some cases, PEMs are produced from pure polymer materials. In other cases, PEMs are produced from composite membranes. In still other cases, PEMs include materials embedded in a polymer matrix. In some embodiments, the PEM includes a fluoropolymer (e.g., a sulfonated tetrafluoroethylene based fluoropolymer-copolymer). PEM electrolyzers are described in, e.g., the exemplary disclosures provided in the Methods section.

In some versions, the electrolyzer is a solid oxide electrolysis (SOE) electrolyzer. In embodiments, SOE electrolyzers operate at temperatures ranging from 650-1000° C. Steam is fed through a porous cathode to which a voltage is applied. Oxygen ions (O²⁻) pass through a solid oxide electrolyte to the anode where said ions are oxidized to form O₂. Any convenient solid oxide electrolyte may be employed. In certain cases, the solid oxide electrolyte is a dense ionic conductor, such as a dense ionic conductor consisting of ZrO₂ doped with Y₂O₃. In some cases, the solid oxide electrolyte includes Scandia stabilized zirconia (ScSZ), ceria based electrolytes, lanthanum gallate materials, or the like, and combinations thereof. Cathode materials include, but are not limited to, Y₂O₃ doped with nickel, lanthanum strontium manganese, lanthanum strontium manganese doped with scandium, or the like, and combinations thereof. Anode materials include, but are not limited to, lanthanum strontium manganate, manganate impregnated with Gd-doped CeO₂, or the like, and combinations thereof. SOE electrolyzers are described in, e.g., the exemplary disclosure provided in the Methods section.

Electrolyzers of the subject invention are gaseously connected to the power generator such that the synthesized gaseous O₂ oxidizes at least a portion of the fuel. In other words, the electrolyzer and power generator include a conduit (e.g., pipe, tubing, etc.) positioned therebetween configured to convey the synthesized gaseous O₂ from the electrolyzer to the power generator. Accordingly, gaseous O₂ synthesized by the electrolyzer is consumed by the power generator.

Select embodiments of the subject systems also include a heat exchanger configured to provide heat produced by the power generator to the electrolyzer. Because the water electrolysis reaction is endothermic, heat is consumed in order to synthesize H₂ and O₂. Accordingly, systems may be configured to supply heat produced during the oxidization of the fuel or the subsequent heat recovery portion of the power generating system, such as in a HRSG, to the electrolysis reaction.

As discussed above, electrolyzers obtain electrical energy from the power generator. In certain cases, systems are configured to generate and/or receive additional electrical energy (i.e., energy in addition to that obtained from the subject power generator). The additional electrical energy may be employed by the electrolyzer and/or another part of the system, as necessary or desired. Any suitable source of electrical energy may be employed as the additional electrical energy. Sources of interest include, but are not limited to, fossil fuels (e.g., coal, oil, and/or natural gas), nuclear power or green (e.g., renewable) power sources. Where the additional electrical energy is obtained from a green power source, the green power source may include, for example, a wind power source, a hydroelectric power source, a solar power source, a hydrogen power source, or the like.

In embodiments, systems are configured to obtain additional purified water, e.g., to supplement the H₂O in the CO₂-depleted H₂O being electrolyzed. Such embodiments of the present systems may include, for example, one or more (e.g., a network of) pipes. The additional purified water may be obtained from any convenient source, such as by a water treatment unit. In some cases, the additional purified water is obtained using a reverse osmosis protocol. Reverse osmosis employs pressure and/or one or more semipermeable membranes to purify water. In certain versions of reverse osmosis, water is passed through one or more semipermeable membranes in order to remove salt and/or minerals and/or other impurities therefrom. In other embodiments, the additional purified water is obtained using a distillation protocol. Such protocols may involve boiling water (e.g., salt water) and collecting water (e.g., water vapor) having a significantly reduced or eliminated salt and/or other impurity concentration.

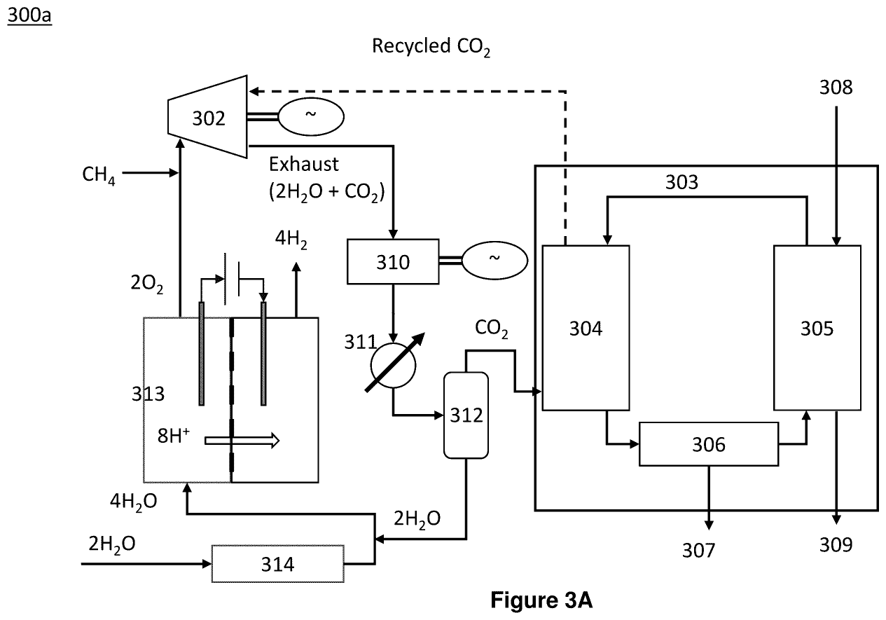

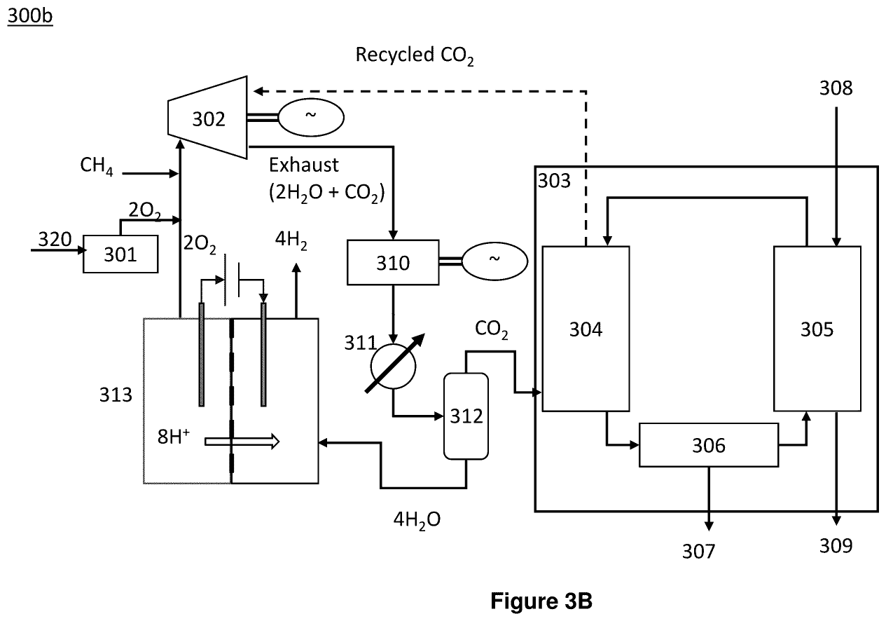

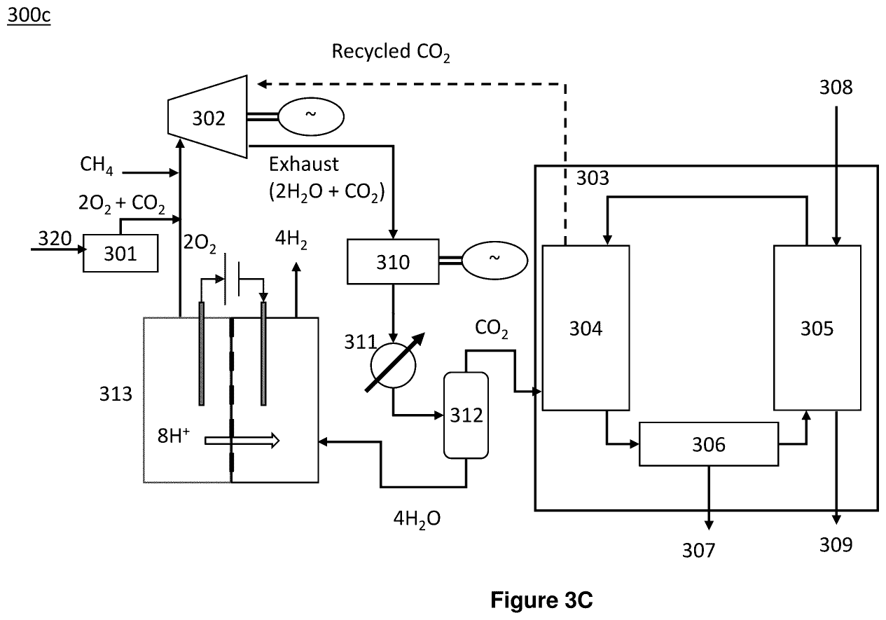

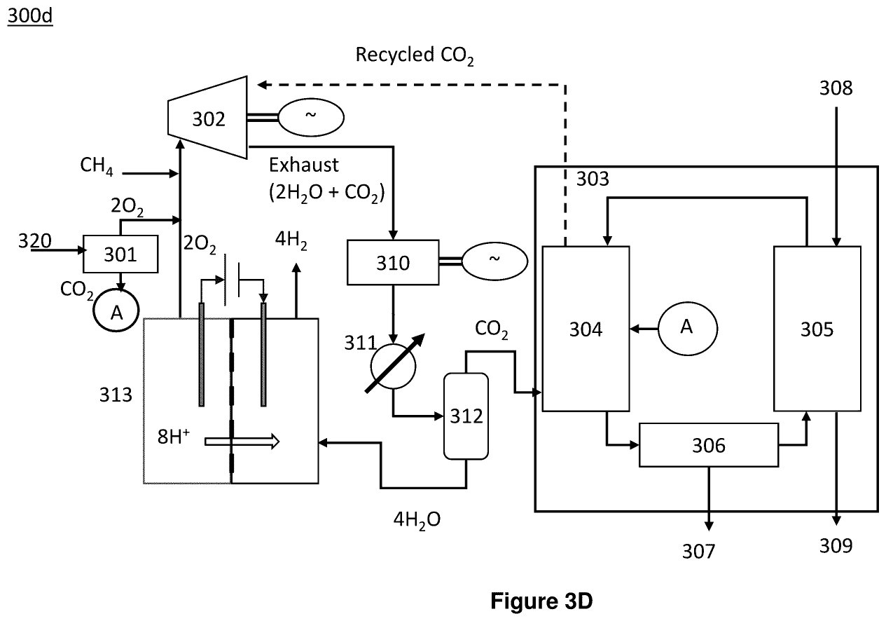

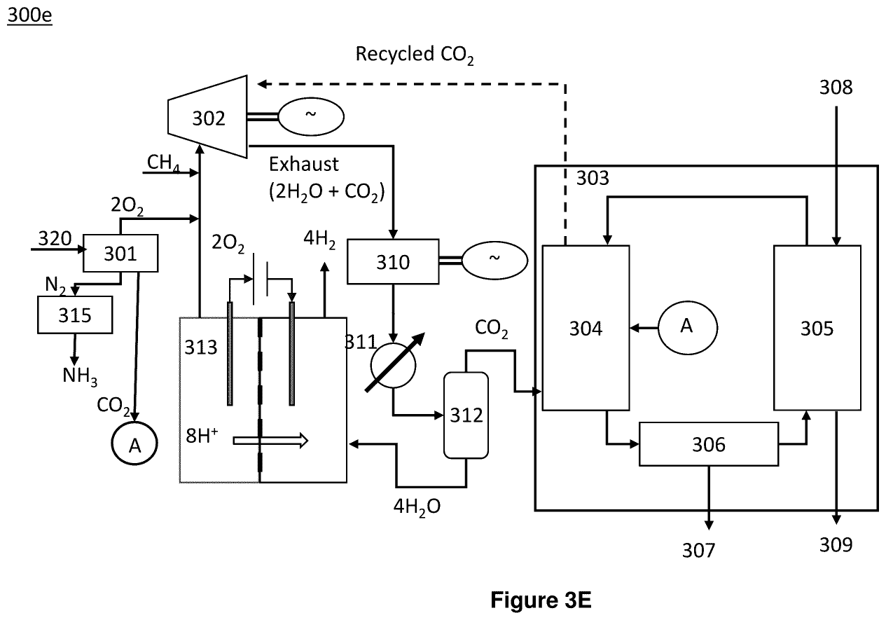

FIG. 3A depicts a schematic block diagram of a system 300a for synthesizing H₂ that is connected to a supplementary water source according to certain embodiments. As shown in FIG. 3A, a power generator comprising a gas turbine 302 is configured to receive a fuel (i.e., CH₄). Also included is an HRSG 310 that receives the exhaust (i.e., comprising H₂O and CO₂) from the gas turbine 302 and produces electrical energy from the heat associated with said exhaust. Heat exchanger 311 is configured to cool the exhaust and separate the H₂O from the CO₂ in separator 312. The resulting H₂O is subsequently supplied to electrolyzer 313, which is configured to synthesize H₂ and O₂. The electrolyzer is gaseously connected to the gas turbine 302 such that the synthesized O₂ is combusted. Heat exchanger 311 is configured to provide at least a portion of the residual heat from the exhaust to the electrolyzer. In the example of FIG. 3A, the system includes a water treatment unit 314 configured to supply purified water to the electrolyzer to supplement the water from the separator 312. In addition, FIG. 3A includes a sequestration unit 303. This unit includes a CO₂ absorber 304 configured to absorb at least a portion of the CO₂, i.e., in aqueous capture ammonia. Some of the remaining CO₂ leaving CO₂ absorber 304 may be returned to the gas turbine 302 where it can serve as a diluent. The capture liquid having CO₂ dissolved therein is then transferred to an agglomeration module 306, where a solid precipitate 307 is produced via the addition of a divalent cation. The aqueous capture ammonia is subsequently regenerated by a reformer 305 so it may be used in the CO₂ absorber 304 once again. The reformer 305 is configured to receive an alkalinity source 308, and output a reformation product 309. When the alkalinity source 308 is returned or recycled concrete, then the reformation product 309 is an “upcycled” material that is called “URCA.”

FIG. 3B depicts a schematic block diagram of a system 300b for synthesizing H₂. In addition to the components described above with respect to FIG. 3A (with the exception of water treatment unit 314), FIG. 3B includes an ASU 301 configured to obtain gaseous O₂ from the surrounding air. Gaseous O₂ from ASU 301 is combined with gaseous O₂ synthesized by electrolyzer 313 and provided to gas turbine 302.

In certain cases, the system is configured to obtain an O₂-containing gas 320 from the surrounding atmosphere for oxidizing the fuel. The O₂-containing gas may be obtained via any convenient protocol. In embodiments, the system includes an ASU, a unit configured to separate air into its components, as discussed above. In some cases, the system is configured to obtain the O₂-containing gas via fractional distillation. For example, in some instances, obtaining the O₂-containing gas includes a cryogenic distillation process, e.g., where gasses are first cooled to the point of liquification and the selectively distilled at their respective boiling temperatures. In some cases, the O₂-containing gas is obtained via a pressure swing adsorption (PSA) process. PSA operates by separating gasses based on their affinity for an adsorbent material. PSA generally operates under high pressure. In some instances, the O₂-containing gas is obtained via a vacuum pressure swing adsorption (VPSA) process. VPSA differs from PSA in that it segregates gases at ambient pressure, but subsequently employs a vacuum to regenerate the adsorbent material. Units for obtaining the O₂-containing gas may be adapted from the exemplary disclosures provided in the Methods section.

As discussed above, the gaseous O₂ synthesized via electrolysis oxidizes at least a portion of the fuel. In some embodiments where an O₂-containing gas is obtained, systems are configured to supply both synthesized O₂ and the O₂-containing gas to the power generator for oxidization. In these embodiments, the ratio of synthesized gaseous O₂ to the obtained O₂-containing gas oxidizing the fuel may vary. In certain embodiments, the ratio of synthesized gaseous O₂ to the obtained O₂-containing gas oxidizing the fuel ranges from 99:1 to 1:99, such as 90:10 to 10:90, such as 80:20 to 20:80, such as 70:30 to 30:70, such as 60:40 to 40:60, and including 55:45 to 45:55. In certain cases, the ratio of synthesized gaseous O₂ to the obtained O₂-containing gas oxidizing the fuel is (or approximates) 50:50.

In some embodiments, the O₂-containing gas 320 further comprises CO₂. In such embodiments, systems are configured to obtain CO₂ from the atmosphere (e.g., directly from the atmosphere) in addition to the exhaust. In certain cases, systems include a direct air capture (DAC) module. DAC involves a class of technologies capable of separating carbon dioxide CO₂ directly from ambient air. A DAC system is any system that captures CO₂ directly from air and generates a product gas that includes CO₂ at a higher concentration than that of the air that is input into the DAC system. DAC systems of interest include, but are not limited to: hydroxide based systems; CO₂ sorbent/temperature swing based systems, and CO₂ sorbent/temperature swing based systems. In some instances, the DAC system is a hydroxide based system, in which CO₂ is separated from air by contacting the air with is an aqueous hydroxide liquid. In some instances, the DAC system is a CO₂ sorbent based system, in which CO₂ is separated from air by contacting the air with sorbent, such as an amine sorbent, followed by release of the sorbent captured CO₂ by subjecting the sorbent to one or more stimuli, e.g., change in temperature, change in humidity, etc. Examples of such DAC systems include, but are not limited to, those provided in the Methods section.

FIG. 3C depicts a schematic block diagram of a system 300c for synthesizing H₂. FIG. 3C includes the components described above with respect to FIG. 3A-B with the exception of water treatment unit 314. In the embodiment of FIG. 3C, ASU 301 is additionally configured to obtain an O₂-containing gas 320 that further comprises CO₂. The CO₂ in the O₂-containing gas 320 is provided to gas turbine 302 where it may serve as a diluent to control the oxidization rate. The CO₂ from ASU 301, in addition to the CO₂ resulting from combustion, is sequestered in sequestration unit 303.

FIG. 3D depicts a schematic block diagram of a system 300d for synthesizing H₂. FIG. 3D is like FIG. 3C with the exception that the CO₂ from ASU 301 is provided directly to absorber 304 of sequestration unit 303 instead of gas turbine 302.

FIG. 3E depicts a schematic block diagram of a system 300e for synthesizing H₂ and NH₃. FIG. 3E is like FIG. 3D with the addition of a reactor 315 configured to synthesize NH₃ from H₂ synthesized by electrolyzer 313. In addition to producing a O₂-containing gas 320 comprising CO₂, ASU 301 in the embodiment of FIG. 3E is configured to obtain N₂ from the surrounding atmosphere and provide the same to reactor 315 for the synthesis of NH₃. While FIGS. 3A-D do not illustrate a reactor configured to synthesize NH₃ from H₂ synthesized by electrolyzer 313, it is noted here that each of those systems could incorporate a similar reactor 315 and generate NH₃ with a very low CO₂ footprint.

In certain cases, the gaseous N₂ employed in NH₃ production is received from the atmosphere, e.g., by an ASU 301, as discussed above. For example, embodiments of the subject systems are configured to produce NH₃ via the Haber-Bosch process. This process and other processes like it (e.g., Kellogg Advanced Ammonia Process (KAAP)) react N₂ with H₂ in the presence of a metal catalyst under high temperature (e.g., 400-600° C.) and pressure (e.g., 20-100 MPa), e.g., as described above in the Methods section.

### Building Materials Produced by the Methods

As reviewed above, the methods of the invention may be employed to produce building materials such as carbonate coated aggregates, e.g., for use in concretes and other applications. The carbonate coated aggregates may be conventional or lightweight aggregates. Aspects of the invention include CO₂ sequestering aggregate compositions. The CO₂ sequestering aggregate compositions include aggregate particles having a core and a CO₂ sequestering carbonate coating on at least a portion of a surface of the core. The CO₂ sequestering carbonate coating is made up of a CO₂ sequestering carbonate material, e.g., as described above.

The CO₂ sequestering carbonate material that is present in coatings of the coated particles of the subject aggregate compositions may vary. In some instances, the carbonate material is a highly reflective microcrystalline/amorphous carbonate material. As the materials may be highly reflective, the coatings that include the same may have a high total surface reflectance (TSR) value. TSR may be determined using any convenient protocol, such as ASTM E1918 Standard Test Method for Measuring Solar Reflectance of Horizontal and Low-Sloped Surfaces in the Field (see also R. Levinson, H. Akbari, P. Berdahl, Measuring solar reflectance—Part II: review of practical methods, LBNL 2010).

In some instances, the coatings that include the carbonate materials are highly reflective of near infra-red (NIR) light, ranging in some instances from 10 to 99%, such as 50 to 99%. By NIR light is meant light having a wavelength ranging from 700 nanometers (nm) to 2.5 mm. NIR reflectance may be determined using any convenient protocol, such as ASTM C1371-04a(2010)e1 Standard Test Method for Determination of Emittance of Materials Near Room Temperature Using Portable Emissometers (http://www(dot)astm(dot)org/Standards/C1371(dot)htm) or ASTM G173-03(2012) Standard Tables for Reference Solar Spectral Irradiances: Direct Normal and Hemispherical on 37° Tilted Surface (http://rredc(dot)nrel(dot)gov/solar/spectra/am 1(dot)5/ASTMG173/ASTMG173(dot)html). In some instances, the coatings exhibit a NIR reflectance value ranging from Rg;0=0.0 to Rg;0=1.0, such as Rg;0=0.25 to Rg;0=0.99, including Rg;0=0.40 to Rg;0=0.98, e.g., as measured using the protocol referenced above.

In some instances, the carbonate coatings are highly reflective of ultra violet (UV) light, ranging in some instances from 10 to 99%, such as 50 to 99%. By UV light is meant light having a wavelength ranging from 400 nm and 10 nm. UV reflectance may be determined using any convenient protocol, such as ASTM G173-03(2012) Standard Tables for Reference Solar Spectral Irradiances: Direct Normal and Hemispherical on 37° Tilted Surface. In some instances, the materials exhibit a UV value ranging from Rg;0=0.0 to Rg;0=1.0, such as Rg;0=0.25 to Rg;0=0.99, including Rg;0=0.4 to Rg;0=0.98, e.g., as measured using the protocol referenced above.

In some instances, the coatings are reflective of visible light, e.g., where reflectivity of visible light may vary, ranging in some instances from 10 to 99%, such as 10 to 90%. By visible light is meant light having a wavelength ranging from 380 nm to 740 nm. Visible light reflectance properties may be determined using any convenient protocol, such as ASTM G173-03(2012) Standard Tables for Reference Solar Spectral Irradiances: Direct Normal and Hemispherical on 37° Tilted Surface. In some instances, the coatings exhibit a visible light reflectance value ranging from Rg;0=0.0 to Rg;0=1.0, such as Rg;0=0.25 to Rg;0=0.99, including Rg;0=0.4 to Rg;0=0.98, e.g., as measured using the protocol referenced above.

The materials making up the carbonate components are, in some instances, amorphous or microcrystalline. Where the materials are microcrystalline, the crystal size, e.g., as determined using the Scherrer equation applied to the FWHM of X-ray diffraction pattern, is small, and in some instances is 1000 microns or less in diameter, such as 100 microns or less in diameter, and including 10 microns or less in diameter. In some instances, the crystal size ranges in diameter from 1000 μm to 0.001 μm, such as 10 to 0.001 μm, including 1 to 0.001 μm. In some instances, the crystal size is chosen in view of the wavelength(s) of light that are to be reflected. For example, where light in the visible spectrum is to be reflected, the crystal size range of the materials may be selected to be less than one-half the “to be reflected” range, so as to give rise to photonic band gap. For example, where the to be reflected wavelength range of light is 100 to 1000 nm, the crystal size of the material may be selected to be 50 nm or less, such as ranging from 1 to 50 nm, e.g., 5 to 25 nm. In some embodiments, the materials produced by methods of the invention may include rod-shaped crystals and amorphous solids. The rod-shaped crystals may vary in structure, and in certain embodiments have length to diameter ratio ranging from 500 to 1, such as 10 to 1. In certain embodiments, the length of the crystals ranges from 0.5 μm to 500 μm, such as from 5 μm to 100 μm. In yet other embodiments, substantially completely amorphous solids are produced.

The density, porosity, and permeability of the coating materials may vary according to the application. With respect to density, while the density of the material may vary, in some instances the density ranges from 5 g/cm³ to 0.01 g/cm³, such as 3 g/cm³ to 0.3 g/cm³ and including 2.7 g/cm³ to 0.4 g/cm³. With respect to porosity, as determined by Gas Surface Adsorption as determined by the BET method (Brunauer-Emmett-Teller (e.g., as described in E. Teller, J. Am. Chem. Soc., 1938, 60, 309. doi:10.1021/ja01269a023) the porosity may range in some instances from 100 m²/g to 0.1 m²/g, such as 60 m²/g to 1 m²/g and including 40 m²/g to 1.5 m²/g. With respect to permeability, in some instances the permeability of the material may range from 0.1 to 100 darcies, such as 1 to 10 darcies, including 1 to 5 darcies (e.g., as determined using the protocol described in H. Darcy, Les Fontaines Publiques de la Ville de Dijon, Dalmont, Paris (1856)). Permeability may also be characterized by evaluating water absorption of the material. As determined by water absorption protocol, e.g., the water absorption of the material ranges, in some embodiments, from 0 to 25%, such as 1 to 15% and including from 2 to 9%.

The hardness of the materials may also vary. In some instances, the materials exhibit a Mohs hardness of 3 or greater, such as 5 or greater, including 6 or greater, where the hardness ranges in some instances from 3 to 8, such as 4 to 7 and including 5 to 6 Mohs (e.g., as determined using the protocol described in American Federation of Mineralogical Societies. “Mohs Scale of Mineral Hardness”). Hardness may also be represented in terms of tensile strength, e.g., as determined using the protocol described in ASTM C1167. In some such instances, the material may exhibit a compressive strength of 100 to 3000 N, such as 400 to 2000 N, including 500 to 1800 N.

In some embodiments, the carbonate material includes one or more contaminants predicted not to leach into the environment by one or more tests selected from the group consisting of Toxicity Characteristic Leaching Procedure (TCLP), Extraction Procedure Toxicity Test, Synthetic Precipitation Leaching Procedure, California Waste Extraction Test, Soluble Threshold Limit Concentration, American Society for Testing and Materials Extraction Test, and Multiple Extraction Procedure. Tests and combinations of tests may be chosen depending upon likely contaminants and storage conditions of the composition. For example, in some embodiments, the composition may include As, Cd, Cr, Hg, and Pb (or products thereof), each of which might be found in a waste gas stream of a coal-fired power plant. Since TCLP tests for As, Ba, Cd, Cr, Pb, Hg, Se, and Ag, TCLP may be an appropriate test for aggregates described herein. In some embodiments, a carbonate composition of the invention includes As, wherein the composition is predicted not to leach As into the environment. For example, a TCLP extract of the composition may provide less than 5.0 mg/L As indicating that the composition is not hazardous with respect to As. In some embodiments, a carbonate composition of the invention includes Cd, wherein the composition is predicted not to leach Cd into the environment. For example, a TCLP extract of the composition may provide less than 1.0 mg/L Cd indicating that the composition is not hazardous with respect to Cd. In some embodiments, a carbonate composition of the invention includes Cr, wherein the composition is predicted not to leach Cr into the environment. For example, a TCLP extract of the composition may provide less than 5.0 mg/L Cr indicating that the composition is not hazardous with respect to Cr. In some embodiments, a carbonate composition of the invention includes Hg, wherein the composition is predicted not to leach Hg into the environment. For example, a TCLP extract of the composition may provide less than 0.2 mg/L Hg indicating that the composition is not hazardous with respect to Hg. In some embodiments, a carbonate composition of the invention includes Pb, wherein the composition is predicted not to leach Pb into the environment. For example, a TCLP extract of the composition may provide less than 5.0 mg/L Pb indicating that the composition is not hazardous with respect to Pb. In some embodiments, a carbonate composition and aggregate that includes of the same of the invention may be non-hazardous with respect to a combination of different contaminants in a given test. For example, the carbonate composition may be non-hazardous with respect to all metal contaminants in a given test. A TCLP extract of a composition, for instance, may be less than 5.0 mg/L in As, 100.0 mg/L in Ba, 1.0 mg/L in Cd, 5.0 mg/mL in Cr, 5.0 mg/L in Pb, 0.2 mg/L in Hg, 1.0 mg/L in Se, and 5.0 mg/L in Ag. Indeed, a majority if not all of the metals tested in a TCLP analysis on a composition of the invention may be below detection limits. In some embodiments, a carbonate composition of the invention may be non-hazardous with respect to all (e.g., inorganic, organic, etc.) contaminants in a given test. In some embodiments, a carbonate composition of the invention may be non hazardous with respect to all contaminants in any combination of tests selected from the group consisting of Toxicity Characteristic Leaching Procedure, Extraction Procedure Toxicity Test, Synthetic Precipitation Leaching Procedure, California Waste Extraction Test, Soluble Threshold Limit Concentration, American Society for Testing and Materials Extraction Test, and Multiple Extraction Procedure. As such, carbonate compositions and aggregates including the same of the invention may effectively sequester CO₂ (e.g., as carbonates, bicarbonates, or a combination thereof) along with various chemical species (or co-products thereof) from waste gas streams, industrial waste sources of divalent cations, industrial waste sources of proton-removing agents, or combinations thereof that might be considered contaminants if released into the environment. Compositions of the invention incorporate environmental contaminants (e.g., metals and co-products of metals such as Hg, Ag, As, Ba, Be, Cd, Co, Cr, Cu, Mn, Mo, Ni, Pb, Sb, Se, TI, V, Zn, or combinations thereof) in a non-leachable form.

The aggregate compositions of the invention include particles having a core region and a CO₂ sequestering carbonate coating on at least a portion of a surface of the core. The coating may cover 10% or more, 20% or more, 30% or more, 40% or more, 50% or more, 60% or more, 70% or more, 80% or more, 90% or more, including 95% or more of the surface of the core. The thickness of the carbonate layer may vary, as desired. In some instances, the thickness may range from 0.1 μm to 10 mm, such as 1 μm to 1000 μm, including 10 μm to 500 μm.

The core of the coated particles of the aggregate compositions described herein may vary widely. The core may be made up of any convenient aggregate material. Examples of suitable aggregate materials include, but are not limited to: natural mineral aggregate materials, e.g., carbonate rocks, sand (e.g., natural silica sand), sandstone, gravel, granite, diorite, gabbro, basalt, etc.; and synthetic aggregate materials, such as industrial byproduct aggregate materials, e.g., blast-furnace slag, fly ash, municipal waste, and recycled concrete, etc. In some instances, the core comprises a material that is different from the carbonate coating.

In some instances, the aggregates are lightweight aggregates. In such instances, the core of the coated particles of the aggregate compositions described herein may vary widely, so long as when it is coated it provides for the desired lightweight aggregate composition. The core may be made up of any convenient material. Examples of suitable aggregate materials include, but are not limited to: conventional lightweight aggregate materials, e.g., naturally occurring lightweight aggregate materials, such as crushed volcanic rocks, e.g., pumice, scoria or tuff, and synthetic materials, such as thermally treated clays, shale, slate, diatomite, perlite, vermiculite, blast-furnace slag and fly ash; as well as unconventional porous materials, e.g., crushed corals, synthetic materials like polymers and low density polymeric materials, recycled wastes such as wood, fibrous materials, cement kiln dust residual materials, recycled glass, various volcanic minerals, granite, silica bearing minerals, mine tailings and the like.

The physical properties of the coated particles of the aggregate compositions may vary. Aggregates of the invention have a density that may vary so long as the aggregate provides the desired properties for the use for which it will be employed, e.g., for the building material in which it is employed. In certain instances, the density of the aggregate particles ranges from 1.1 to 5 gm/cc, such as 1.3 gm/cc to 3.15 gm/cc, and including 1.8 gm/cc to 2.7 gm/cc. Other particle densities in embodiments of the invention, e.g., for lightweight aggregates, may range from 1.1 to 2.2 gm/cc, e.g., 1.2 to 2.0 g/cc or 1.4 to 1.8 g/cc. In some embodiments the invention provides aggregates that range in bulk density (unit weight) from 50 lb/lb/ft³ to 200 lb/ft³, or 75 lb/ft³ to 175 lb/ft³, or 50 lb/ft³ to 100 lb/ft³, or 75 lb/ft³ to 125 lb/ft³, or lb/ft³ to 115 lb/ft³, or 100 lb/ft³ to 200 lb/ft³, or 125 lb/ft³ to lb/ft³, or 140 lb/ft³ to 160 lb/ft³, or 50 lb/ft³ to 200 lb/ft³. Some embodiments of the invention provide lightweight aggregate, e.g., aggregate that has a bulk density (unit weight) of 75 lb/ft³ to 125 lb/ft³, such as 90 lb/ft³ to 115 lb/ft³. In some instances, the lightweight aggregates have a weight ranging from 50 to 1200 kg/m³, such as 80 to 11 kg/m³.

The hardness of the aggregate particles making up the aggregate compositions of the invention may also vary, and in certain instances the hardness, expressed on the Mohs scale, ranges from 1.0 to 9, such as 1 to 7, including 1 to 6 or 1 to 5. In some embodiments, the Mohr's hardness of aggregates of the invention ranges from 2-5, or 2-4. In some embodiments, the Mohs hardness ranges from 2-6. Other hardness scales may also be used to characterize the aggregate, such as the Rockwell, Vickers, or Brinell scales, and equivalent values to those of the Mohs scale may be used to characterize the aggregates of the invention; e.g., a Vickers hardness rating of 250 corresponds to a Mohs rating of 3; conversions between the scales are known in the art.

The abrasion resistance of an aggregate may also be important, e.g., for use in a roadway surface, where aggregates of high abrasion resistance are useful to keep surfaces from polishing. Abrasion resistance (i.e., abrasion value) is related to hardness but is not the same. Aggregates of the invention include aggregates that have an abrasion resistance similar to that of natural limestone, or aggregates that have an abrasion resistance superior to natural limestone, as well as aggregates having an abrasion resistance lower than natural limestone, as measured by art accepted methods, such as ASTM C131-03, the Los Angeles Abrasion Test, and the Micro Deval Test. In some embodiments aggregates of the invention have an abrasion resistance of less than 50%, or less than 40%, or less than 35%, or less than 30%, or less than 25%, or less than 20%, or less than 15%, or less than 10%, when measured by ASTM C131-03. In some embodiments aggregates of the invention have an abrasion value of less than 40%, or less than 35%, or less than 30%, or less than 25%, or less than 20%, or less than 15%, or less than 10%, when measured by the Los Angeles Abrasion Test. In some embodiments aggregates of the invention have an abrasion value of less than 25%, or less than 20%, or less than 15%, or less than 10%, when measured by the Micro Deval Test.

Aggregates of the invention may also have a porosity within particular ranges. As will be appreciated by those of skill in the art, in some cases a highly porous aggregate is desired, in others an aggregate of moderate porosity is desired, while in other cases aggregates of low porosity, or no porosity, are desired. Porosities of aggregates of some embodiments of the invention, as measured by water uptake after oven drying followed by full immersion for 60 minutes, expressed as % dry weight, can be in the range of 1-40%, such as 2-20%, or 2-15%, including 2-10% or even 3-9%.

The dimensions of the aggregate particles may vary. Aggregate compositions of the invention are particulate compositions that may in some embodiments be classified as fine or coarse. Fine aggregates according to embodiments of the invention are particulate compositions that almost entirely pass through a Number 4 sieve (ASTM C 125 and ASTM C 33). Fine aggregate compositions according to embodiments of the invention have an average particle size ranging from 10 μm to 4.75 mm, such as 50 μm to 3.0 mm and including 75 μm to 2.0 mm. Coarse aggregates of the invention are compositions that are predominantly retained on a Number 4 sieve (ASTM C 125 and ASTM C 33). Coarse aggregate compositions according to embodiments of the invention are compositions that have an average particle size ranging from 4.75 mm to 200 mm, such as 4.75 to 150 mm in and including 5 to 100 mm. As used herein, “aggregate” may also in some embodiments encompass larger sizes, such as 3 in to 12 in or even 3 in to 24 in, or larger, such as 12 in to 48 in, or larger than 48 in.

### Compositions Including Building Materials

Aspects of the invention also include compositions that include building materials (e.g., aggregates) of the invention. Compositions of interest include, for example, concrete dry composites, settable compositions, and built structures.

### Concrete Dry Composites

Provided herein are concrete dry composites including a building material (e.g., aggregate) of the invention, upon combination with a suitable setting liquid (such as described below), produce a settable composition that sets and hardens into a concrete or a mortar. Concrete dry composites as described herein include an amount of an aggregate, e.g., as described above, and a cement, such as a hydraulic cement. The term “hydraulic cement” is employed in its conventional sense to refer to a composition which sets and hardens after combining with water or a solution where the solvent is water, e.g., an admixture solution. The setting and hardening of the product produced by combination of the concrete dry composites of the invention with an aqueous liquid results from the production of hydrates that are formed from the cement upon reaction with water, where the hydrates are essentially insoluble in water.

Aggregates of the invention find use in place of conventional natural rock aggregates used in conventional concrete when combined with pure Portland cement. Other hydraulic cements of interest in certain embodiments are Portland cement blends. The phrase “Portland cement blend” includes a hydraulic cement composition that includes a Portland cement component and significant amount of a non-Portland cement component. As the cements of the invention are Portland cement blends, the cements include a Portland cement component. The Portland cement component may be any convenient Portland cement. As is known in the art, Portland cements are powder compositions produced by grinding Portland cement clinker (more than 90%), a limited amount of calcium sulfate which controls the set time, and up to 5% minor constituents (as allowed by various standards). When the exhaust gases used to provide carbon dioxide for the reaction contain SOx, then sufficient sulphate may be present as calcium sulfate in the precipitated material, either as a cement or aggregate to offset the need for additional calcium sulfate. As defined by the European Standard EN197.1, “Portland cement clinker is a hydraulic material which shall consist of at least two-thirds by mass of calcium silicates (3CaO·SiO₂ and 2CaO·SiO₂), the remainder consisting of aluminum- and iron-containing clinker phases and other compounds. The ratio of CaO to SiO₂ shall not be less than 2.0. The magnesium content (MgO) shall not exceed 5.0% by mass.” The concern about MgO is that later in the setting reaction, magnesium hydroxide, brucite, may form, leading to the deformation and weakening and cracking of the cement. In the case of magnesium carbonate containing cements, brucite will not form as it may with MgO. In certain embodiments, the Portland cement constituent of the present invention is any Portland cement that satisfies the ASTM Standards and Specifications of C150 (Types I-VIII) of the American Society for Testing of Materials (ASTM C50-Standard Specification for Portland Cement). ASTM C150 covers eight types of Portland cement, each possessing different properties, and used specifically for those properties.

Also of interest as hydraulic cements are carbonate-containing hydraulic cements. Such carbonate-containing hydraulic cements, methods for their manufacture and use are described in U.S. Pat. No. 7,735,274; the disclosure of which applications are herein incorporated by reference.

In certain embodiments, the hydraulic cement may be a blend of two or more different kinds of hydraulic cements, such as Portland cement and a carbonate containing hydraulic cement. In certain embodiments, the amount of a first cement, e.g., Portland cement in the blend ranges from 10 to 90% (w/w), such as 30 to 70% (w/w) and including 40 to 60% (w/w), e.g., a blend of 80% ordinary Portland cement (OPC) and 20% carbonate hydraulic cement.

In some instances, the concrete dry composite compositions, as well as concretes produced therefrom, have a CarbonStar Rating (CSR) that is less than the CSR of the control composition that does not include an aggregate of the invention. The Carbon Star Rating (CSR) is a value that characterizes the embodied carbon (in the form of CaCO₃) for any product, in comparison to how carbon intensive production of the product itself is (i.e., in terms of the production CO₂). The CSR is a metric based on the embodied mass of CO₂ in a unit of concrete. Of the three components in concrete—water, cement and aggregate—cement is by far the most significant contributor to CO₂ emissions, roughly 1:1 by mass (1 ton cement produces roughly 1 ton CO₂). So, if a cubic yard of concrete uses 600 lb cement, then its CSR is 600. A cubic yard of concrete according to embodiments of the present invention which include 600 lb cement and in which at least a portion of the aggregate is carbonate coated aggregate, e.g., as described above, will have a CSR that is less than 600, e.g., where the CSR may be 550 or less, such as 500 or less, including 400 or less, e.g., 250 or less, such as 100 or less, where in some instances the CSR may be a negative value, e.g., −100 or less, such as −500 or less including −1000 or less, where in some instances the CSR of a cubic yard of concrete having 600 lbs cement may range from 500 to −5000, such as −100 to −4000, including −500 to −3000. To determine the CSR of a given cubic yard of concrete that includes carbonate coated aggregate of the invention, an initial value of CO₂ generated for the production of the cement component of the concrete cubic yard is determined. For example, where the yard includes 600 lbs of cement, the initial value of 600 is assigned to the yard. Next, the amount of carbonate coating in the yard is determined. Since the molecular weight of carbonate is 100 a.u., and 44% of carbonate is CO₂, the amount of carbonate coating is present in the yard is then multiplied by 0.44 and the resultant value subtracted from the initial value in order to obtain the CSR for the yard. For example, where a given yard of concrete mix is made up of 600 lbs of cement, 300 lbs of water, 1429 lbs of fine aggregate and 1739 lbs of coarse aggregate, the weight of a yard of concrete is 4068 lbs and the CSR is 600. If 10% of the total mass of aggregate in this mix is replaced by carbonate coating, e.g., as described above, the amount of carbonate present in the revised yard of concrete is 317 lbs. Multiplying this value by 0.44 yields 139.5. Subtracting this number from 600 provides a CSR of 460.5.

### Settable Compositions

Settable compositions of the invention, such as concretes and mortars, are produced by combining a hydraulic cement with an amount of an aggregate of the invention and an aqueous liquid, e.g., water, either at the same time or by pre-combining the cement with aggregate, and then combining the resultant dry components with water. The choice of coarse aggregate material for concrete mixes using cement compositions of the invention may have a minimum size of about ⅜ inch and can vary in size from that minimum up to one inch or larger, including in gradations between these limits. Finely divided aggregate is smaller than ⅜ inch in size and again may be graduated in much finer sizes down to 200-sieve size or so. Fine aggregates may be present in both mortars and concretes of the invention. The weight ratio of cement to aggregate in the dry components of the cement may vary, and in certain embodiments ranges from 1:10 to 4:10, such as 2:10 to 5:10 and including from 55:1000 to 70:100.

The liquid phase, e.g., aqueous fluid, with which the dry component is combined to produce the settable composition, e.g., concrete, may vary, from pure water to water that includes one or more solutes, additives, co-solvents, etc., as desired. The ratio of dry component to liquid phase that is combined in preparing the settable composition may vary, and in certain embodiments ranges from 2:10 to 7:10, such as 3:10 to 6:10 and including 4:10 to 6:10.

In certain embodiments, the cements may be employed with one or more admixtures. Admixtures are compositions added to concrete to provide it with desirable characteristics that are not obtainable with basic concrete mixtures or to modify properties of the concrete to make it more readily useable or more suitable for a particular purpose or for cost reduction. As is known in the art, an admixture is any material or composition, other than the hydraulic cement, aggregate and water, that is used as a component of the concrete or mortar to enhance some characteristic, or lower the cost, thereof. The amount of admixture that is employed may vary depending on the nature of the admixture. In certain embodiments the amounts of these components range from 1 to 50% w/w, such as 2 to 10% w/w.

Admixtures of interest include finely divided mineral admixtures such as cementitious materials; pozzolans; pozzolanic and cementitious materials; and nominally inert materials. Pozzolans include diatomaceous earth, opaline cherts, clays, shales, fly ash, silica fume, volcanic tuffs and pumicites are some of the known pozzolans. Certain ground granulated blast-furnace slags and high calcium fly ashes possess both pozzolanic and cementitious properties. Nominally inert materials can also include finely divided raw quartz, dolomites, limestone, marble, granite, and others. Fly ash is defined in ASTM C618. Other types of admixture of interest include plasticizers, accelerators, retarders, air-entrainers, foaming agents, water reducers, corrosion inhibitors, and pigments.

As such, admixtures of interest include, but are not limited to: set accelerators, set retarders, air-entraining agents, defoamers, alkali-reactivity reducers, bonding admixtures, dispersants, coloring admixtures, corrosion inhibitors, dampproofing admixtures, gas formers, permeability reducers, pumping aids, shrinkage compensation admixtures, fungicidal admixtures, germicidal admixtures, insecticidal admixtures, rheology modifying agents, finely divided mineral admixtures, pozzolans, aggregates, wetting agents, strength enhancing agents, water repellents, and any other concrete or mortar admixture or additive. Admixtures are well-known in the art and any suitable admixture of the above type or any other desired type may be used; see, e.g., U.S. Pat. No. 7,735,274, incorporated herein by reference in its entirety.

In certain embodiments, settable compositions of the invention include a cement employed with fibers, e.g., where one desires fiber-reinforced concrete. Fibers can be made of zirconia containing materials, steel, carbon, fiberglass, or synthetic materials, e.g., polypropylene, nylon, polyethylene, polyester, rayon, high-strength aramid, (i.e., Kevlar®), or mixtures thereof.

The components of the settable composition can be combined using any convenient protocol. Each material may be mixed at the time of work, or part of or all of the materials may be mixed in advance. Alternatively, some of the materials are mixed with water with or without admixtures, such as high-range water-reducing admixtures, and then the remaining materials may be mixed therewith. As a mixing apparatus, any conventional apparatus can be used. For example, Hobart mixer, slant cylinder mixer, Omni Mixer, Henschel mixer, V-type mixer, and Nauta mixer can be employed.

Following the combination of the components to produce a settable composition (e.g., concrete), the settable compositions are in some instances initially flowable compositions, and then set after a given period of time. The setting time may vary, and in certain embodiments ranges from 30 minutes to 48 hours, such as 30 minutes to 24 hours and including from 1 hour to 4 hours.

The strength of the set product may also vary. In certain embodiments, the strength of the set cement may range from 5 Mpa to 70 MPa, such as 10 MPa to 50 MPa and including from 20 MPa to 40 MPa. In certain embodiments, set products produced from cements of the invention are extremely durable. e.g., as determined using the test method described at ASTM C1157.

### Built Structures

Aspects of the invention further include structures produced from the aggregates and settable compositions of the invention. As such, further embodiments include manmade structures that contain the aggregates of the invention and methods of their manufacture. Thus, in some embodiments the invention provides a manmade structure that includes one or more aggregates as described herein. The manmade structure may be any structure in which an aggregate may be used, such as a building, dam, levee, roadway or any other manmade structure that incorporates an aggregate or rock. In some embodiments, the invention provides a manmade structure, e.g., a building, a dam, or a roadway, that includes an aggregate of the invention, where the aggregate may be produced from a polymorph precursor composition, e.g., as described above. In some embodiments the invention provides a method of manufacturing a structure, comprising providing an aggregate of the invention.

### Utility

Methods and systems of the invention find use, for example, where it is desirable to increase the efficiency of a Green Hydrogen production protocol. For example, embodiments of the invention allow the production of Green Hydrogen to exceed the amount of renewable energy available in the power grid because the use of natural gas with carbon capture provides an additional source of power for the electrolysis. Additionally, the subject methods and systems provide a solution for the intermittency of other low-carbon sources of power (such as wind and solar). The invention may also be employed in instances where it is desirable to reduce the amount of water needed to produce Green Hydrogen. In embodiments of the systems and methods, the overall water demand for a given amount of Green Hydrogen is nominally halved as compared to conventional Green Hydrogen protocols. That is because half of the hydrogen is actually coming from the hydrogen atoms present in the methane. In this way, the overall reaction may actually be given by Reaction V above. That is, the overall chemistry mimics steam methane reforming. Furthermore, recirculating some of the CO₂ eliminates the requirement for 100% capture per pass through the absorber which reduces the demands on the sequestration system. Because the water electrolysis reaction is endothermic, heat must be supplied to cell in addition to the electrical power. Methods and systems of the invention permit this heat to be sourced from the heat recovered in the exchanger used to condense the water away from the recirculating CO₂. In addition to this heat recovery, the process may be optimized so that the electrolysis cell can run at higher temperatures, which typically provides additional benefits such as reduced resistive losses in the cell.

The subject solid, e.g., aggregate, compositions and settable compositions that include the same, find use in a variety of different applications, such as above ground stable CO₂ sequestration products, as well as building or construction materials. Specific structures in which the settable compositions of the invention find use include, but are not limited to: pavements, architectural structures, e.g., buildings, foundations, motorways/roads, overpasses, bridges, parking structures, brick/block walls and footings for gates, fences and poles. Mortars of the invention find use in binding construction blocks, e.g., bricks, together and filling gaps between construction blocks. Mortars can also be used to fix existing structure, e.g., to replace sections where the original mortar has become compromised or eroded, among other uses.

Notwithstanding the appended claims, the disclosure is also defined by the following clauses:

1. A method of synthesizing NH₃, the method comprising:
oxidizing a fuel in a power generator to generate electrical energy and an exhaust comprising CO₂ and H₂O;
sequestering CO₂ from the exhaust to produce a CO₂-depleted H₂O stream;
electrolyzing H₂O from the CO₂-depleted H₂O stream using the generated electrical energy to synthesize gaseous O₂ and the H₂, wherein the synthesized gaseous O₂ oxidizes at least a portion of the fuel; and synthesizing ammonia (NH₃) from the H₂.
   2. The method according to Clause 1, wherein the power generator comprises a gas turbine.
   3. The method according to Clause 1, wherein the power generator comprises a gas boiler.
   4. The method according to any of the preceding clauses, wherein the power generator comprises a heat recovery steam generator (HRSG).
   5. The method according to any of the preceding clauses, wherein the fuel comprises a natural gas.
   6. The method according to any of the preceding clauses, wherein sequestering the CO₂ from the exhaust comprises contacting an aqueous capture liquid with the exhaust under conditions sufficient to produce an aqueous carbonate.
   7. The method according to Clause 6, further comprising combining cations from a cation source and the aqueous carbonate under conditions sufficient to produce a CO₂ sequestering carbonate.
   8. The method according to Clause 7, wherein the cation source is a source of divalent cations.
   9. The method according to Clause 8, wherein the cation source comprises alkaline earth metal cations.
   10. The method according to Clause 9, wherein the alkaline earth metal cations are selected from the group consisting of Ca²⁺ and Mg²⁺, and combinations thereof.
   11. The method according to any of Clauses 6 to 10, wherein the aqueous capture liquid comprises an aqueous capture ammonia.
   12. The method according to Clause 11, wherein combining the cation source and the aqueous ammonium carbonate produces a CO₂ sequestering carbonate and an aqueous ammonium salt.
   13. The method according to Clause 12, further comprising regenerating aqueous capture ammonia from the aqueous ammonium salt.
   14. The method according to any of Clauses 6 to 10, wherein the aqueous capture liquid comprises a proton-removing agent.
   15. The method according to Clause 14, wherein the aqueous capture liquid has a pH of 10 or more.
   16. The method according to any of the preceding clauses, wherein electrolyzing the generated H₂O comprises alkaline water electrolysis (AWE).
   17. The method according to any of Clauses 1 to 15, wherein electrolyzing the generated H₂O comprises proton exchange membrane (PEM) electrolysis.
   18. The method according to any of Clauses 1 to 15, wherein electrolyzing the generated H₂O comprises solid oxide electrolysis (SOE).
   19. The method according to any of the previous clauses, wherein additional electrical energy is employed.
   20. The method according to Clause 19, wherein the additional electrical energy is obtained from a green power source.
   21. The method according to Clause 20, wherein the green power source is selected from: a wind power source, a hydroelectric power source, a solar power source and a hydrogen power source.
   22. The method according to any of the preceding clauses, wherein the method comprises obtaining an O₂-containing gas from the surrounding atmosphere for oxidizing the fuel.
   23. The method according to Clause 22, wherein the method comprises obtaining the O₂-containing gas via an air separation unit (ASU).
   24. The method according to Clause 22 or 23, wherein the ratio of synthesized gaseous O₂ to the obtained O₂-containing gas oxidizing the fuel ranges from 60:40 to 40:60.
   25. The method according to any of Clauses 22 to 24, wherein the O₂-containing gas further comprises CO₂.
   26. The method according to Clause 25, wherein obtaining the CO₂ in the O₂ containing gas comprises direct air capture (DAC).
   27. The method according to Clause 25 or 26, further comprising sequestering the CO₂ in the O₂-containing gas.
   28. The method according to Clause 27, wherein the method comprises combining the CO₂ in the O₂-containing gas with the fuel.
   29. The method according to any of Clauses 22 to 28, wherein the method comprises obtaining gaseous N₂.
   30. The method according to Clause 29, further comprising synthesizing ammonia (NH₃) from the H₂ using the N₂.
   31. The method according to any of the preceding clauses, further comprising supplying the power generator with a CO₂ diluent from the exhaust to control the rate of oxidization.
   32. The method according to any of the preceding clauses, further comprising limiting the amount of an oxidization component supplied to the power generator to control the rate of oxidization, wherein the oxidization component is the synthesized gaseous O₂ or the fuel.
   33. The method according to Clause 32, further comprising recycling the non-limited oxidization component to the power generator following oxidization.
   34. The method according to any of the preceding clauses, further comprising cooling the exhaust.
   35. A system comprising:
a power generator configured to oxidize a fuel to generate electrical energy and an exhaust comprising CO₂ and H₂O;
a CO₂ sequestration unit gaseously connected to the power generator and configured to produce a CO₂-depleted H₂O stream;
an electrolyzer configured to electrolyze H₂O from the CO₂-depleted H₂O stream using the electrical energy from the power generator and synthesize gaseous O₂ and H₂, wherein the electrolyzer is gaseously connected to the power generator such that the synthesized gaseous O₂ oxidizes at least a portion of the fuel; and
a reactor configured to synthesize ammonia (NH₃) from the H₂.
   36. The system according to Clause 35, wherein the power generator comprises a gas turbine.
   37. The system according to Clause 35, wherein the power generator comprises a gas boiler.
   38. The system according to any of Clauses 35 to 37, wherein the power generator comprises a heat recovery steam generator (HRSG).
   39. The system according to any of Clauses 35 to 38, wherein the CO₂ sequestration unit is configured to contact an aqueous capture liquid with the exhaust under conditions sufficient to produce an aqueous carbonate.
   40. The system according to Clause 39, wherein the CO₂ sequestration unit is configured to combine cations from a cation source and the aqueous carbonate under conditions sufficient to produce a CO₂ sequestering carbonate.
   41. The system according to Clause 40, wherein the cation source is a source of divalent cations.
   42. The system according to Clause 41, wherein the cation source comprises alkaline earth metal cations.
   43. The system according to Clause 42, wherein the alkaline earth metal cations are selected from the group consisting of Ca²⁺ and Mg²⁺, and combinations thereof.
   44. The system according to any of Clauses 39 to 43, wherein the aqueous capture liquid comprises an aqueous capture ammonia.
   45. The system according to Clause 44, wherein combining the cation source and the aqueous ammonium carbonate produces a CO₂ sequestering carbonate and an aqueous ammonium salt.
   46. The system according to Clause 45, further comprising a reformer configured to regenerate aqueous capture ammonia from the aqueous ammonium salt.
   47. The system according to any of Clauses 39 to 43, wherein the aqueous capture liquid comprises a proton-removing agent.
   48. The system according to Clause 47, wherein the aqueous capture liquid has a pH of 10 or more.
   49. The system according to any of Clauses 35 to 48, wherein the electrolyzer is configured to perform alkaline water electrolysis (AWE).
   50. The system according to any of Clauses 35 to 48, wherein the electrolyzer is configured to perform proton exchange membrane (PEM) electrolysis.
   51. The system according to any of Clauses 35 to 48, wherein the electrolyzer is configured to perform solid oxide electrolysis (SOE).
   52. The system according to any of Clauses 35 to 51, wherein the system is operably connected to an additional power source.
   53. The system according to Clause 52, wherein the additional power source is a green power source.
   54. The system according to Clause 53, the green power source is selected from: a wind power source, a hydroelectric power source, a solar power source and a hydrogen power source.
   55. The system according to any of Clauses 35 to 54, wherein the system is configured to obtain an O₂-containing gas from the surrounding atmosphere for oxidizing the fuel.
   56. The system according to Clause 55, further comprising an air separation unit (ASU) configured to obtain the O₂-containing gas.
   57. The system according to Clause 55 or 56, wherein the ratio of synthesized gaseous O₂ to the obtained O₂-containing gas oxidizing the fuel ranges from 60:40 to 40:60.
   58. The system according to any of Clauses 55 to 57, wherein the system is configured obtain an O₂-containing gas comprising CO₂.
   59. The system according to Clause 58, further comprising a direct air capture (DAC) device configured to obtain gaseous CO₂ from the surrounding atmosphere.
   60. The system according to Clause 58 or 59, further comprising a gaseous connection for supplying the obtained gaseous CO₂ to the power generator.
   61. The system according to Clause 59 or 60, further comprising a gaseous connection for supplying the obtained gaseous CO₂ to the CO₂ sequestration unit.
   62. The system according to any of Clauses 56 to 61, wherein the system is configured obtain N₂ from the surrounding atmosphere.
   63. The system according to Clause 62, wherein the reactor is configured to synthesize ammonia (NH₃) from the H₂ using the N₂.
   64. The system according to any of Clauses 35 to 63, further comprising a diluent recirculation line connecting the CO₂ sequestration unit to the power generator, wherein the diluent recirculation line is configured to transport a CO₂ diluent to the power generator to control the rate of oxidization.
   65. The system according to any of Clauses 35 to 64, wherein the power generator is configured to limit the amount of an oxidization component supplied thereto to control the rate of oxidization, wherein the oxidization component is the gaseous O₂ or the fuel.
   66. The system according to Clause 65, wherein the power generator is configured to recycle the non-limited oxidization component following oxidization.
   67. The system according to any of Clauses 35 to 66, further comprising a condenser configured to cool the exhaust.
   68. The system according to any of Clauses 35 to 67, further comprising a heat exchanger configured to provide heat produced by the power generator to the electrolyzer.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A method of synthesizing NH₃, the method comprising:
oxidizing a fuel in a power generator to generate electrical energy and an exhaust comprising CO₂ and H₂O;
separating most of the CO₂ from the exhaust to produce a CO₂-depleted H₂O stream and a CO₂ stream;
sequestering most of the CO₂ in the CO₂ stream;
electrolyzing H₂O from the CO₂-depleted H₂O stream using at least the generated electrical energy to synthesize gaseous O₂ and the H₂; and
synthesizing ammonia (NH₃) from the H₂ and gaseous N₂.

2. The method according to claim 1, further comprising supplying an oxidization component to the power generator to oxidize the fuel.

3. The method according to claim 2, further comprising supplying the synthesized gaseous O₂ as the oxidization component.

4. The method according to claim 2, further comprising limiting the amount of the oxidization component supplied to the power generator to control a rate of oxidization.

5. The method according to claim 4, further comprising supplying the power generator with a CO₂ diluent from the exhaust to control the rate of oxidization.

6. The method according to claim 4, further comprising recycling the non-limited oxidization component to the power generator following oxidization.

7. The method according to claim 1, wherein electrolyzing H₂O from the CO₂-depleted H₂O stream further comprises employing additional electrical energy that is obtained from a green power source.

8. The method according to claim 3, further comprising supplying O₂ obtained from O₂-containing gas in the surrounding atmosphere as the oxidization component.

9. The method according to claim 8, wherein the ratio of synthesized gaseous O₂ to the obtained O₂-containing gas for oxidizing the fuel ranges from 60:40 to 40:60.

10. The method according to claim 8, further comprising obtaining the O₂-containing gas from the surrounding atmosphere via an air separation unit.

11. The method according to claim 8, further comprising obtaining CO₂ from the O₂-containing gas using direct air capture (DAC).

12. The method according to claim 11, further comprising sequestering the CO₂ obtained from the O₂-containing gas.

13. The method according to claim 11, further comprising supplying the power generator with a CO₂ obtained from O₂-containing gas to control a rate of oxidization of the fuel.

14. The method according to claim 1, further comprising obtaining the gaseous N₂ from the surrounding atmosphere via an air separation unit.

15. The method according to claim 1, wherein sequestering the CO₂ from the exhaust comprises contacting an aqueous capture liquid with the exhaust under conditions sufficient to produce an aqueous carbonate.

16. The method according to claim 15, further comprising combining cations from a cation source and the aqueous carbonate under conditions sufficient to produce a CO₂ sequestering carbonate.

17. The method according to claim 16, wherein the cation source is a source of divalent cations.

18. The method according to claim 17, wherein the cation source comprises alkaline earth metal cations.

19. The method according to claim 18, wherein the alkaline earth metal cations are selected from the group consisting of Ca²⁺ and Mg²⁺, and combinations thereof.

20. The method according to claim 15, further comprising using the synthesized ammonia (NH₃) in the aqueous capture liquid.

21. The method according to claim 16, wherein combining the cation source and the aqueous ammonium carbonate produces a CO₂ sequestering carbonate and an aqueous ammonium salt.
